(19) United States
(12) Patent Application Publication
(10) Pub. No.: US 2025/0253917 A1
(43) Pub. Date: Aug. 7, 2025

(54) BEAM INDICATION METHOD/APPARATUS, DEVICE, AND STORAGE MEDIUM

(71) Applicant: Beijing Xiaomi Mobile Software Co., Ltd., Beijing (CN)

(72) Inventor: Xuemei QIAO, Beijing (CN)

(73) Assignee: Beijing Xiaomi Mobile Software Co., Ltd., Beijing (CN)

(21) Appl. No.: 18/856,913

(22) PCT Filed: Apr. 15, 2022
(86) PCT No.: PCT/CN2022/087232

§ 371 Date: Oct. 15, 2024

(51) Int. Cl. H04B 7/06; H04L 5/00; H04W 72/232; H04W 74/0833

(52) U.S. Cl. CPC H04B 7/06952; H04L 5/0005; H04W 72/232; H04W 74/0833

(57) ABSTRACT

A beam indication method and a communication apparatus are provided. The method includes: acquiring a first signaling and/or a first channel sent by a network device, where the first signaling and/or the first channel is used to indicate a beam; determining the beam indicated by the first signaling and/or the first channel; and performing transmission using the beam.

### CROSS-REFERENCE

The present application is a U.S. National Stage of International Application No. PCT/CN2022/087232, filed on Apr. 15, 2022, the entire content of which is incorporated herein by reference for all purposes.

### TECHNICAL FIELD

The present disclosure relates to a field of communication technology, and more particularly, to a beam indication method/apparatus/device and a non-transitory storage medium.

### BACKGROUND

In a communication system, in order to enhance signal coverage, UE (User Equipment) typically uses multiple different beams to transmit a signaling.

In the related art, when the UE sends the signal using multiple different beams, a network device usually needs to determine a better or best beam (such as the beam with a higher or highest receiving power) from the multiple different beams and indicate it to the UE, such that the UE may subsequently use the beam to communicate with the network device, thereby ensuring communication quality.

Thus, there is an urgent need for a “beam indication” method to indicate the beam to UE.

### SUMMARY

The beam indication method/apparatus/device and a non-transitory storage medium proposed in the present disclosure are used for a network device to indicate a beam to a UE.

The beam indication method is provided according to embodiments of an aspect of the present disclosure, the method is performed by a UE and includes:
acquiring a first signaling and/or a first channel sent by a network device, where the first signaling and/or the first channel is used to indicate a beam;
determining the beam indicated by the first signaling and/or the first channel; and
performing transmission using the beam.

The beam indication method is provided according to embodiments of another aspect of the present disclosure, the method is performed by a network device and includes:
sending a first signaling and/or a first channel to a UE, where the first signaling and/or the first channel is used to indicate a beam; and
performing transmission using the beam.

A communication apparatus is provided according to embodiments of an aspect of the present disclosure, he apparatus includes a processor and a memory, the memory stores a computer program, and the processor executes the computer program stored in the memory to cause the apparatus to: acquire at least one of a first signaling or a first channel sent by a network device, where the at least one of the first signaling or the first channel is used to indicate a beam; determine the beam indicated by the at least one of the first signaling or the first channel; and perform transmission using the beam.

### BRIEF DESCRIPTION OF THE DRAWINGS

The above and/or additional aspects and advantages of the embodiments of the present disclosure will become apparent and more readily from the following descriptions made with reference to the accompanying drawings, in which:

FIG. 1a is a flowchart of a beam indication method provided by an embodiment of the present disclosure;

FIG. 1b is a flowchart of a beam indication method provided by another embodiment of the present disclosure;

FIG. 1c is a flowchart of a beam indication method provided by yet another embodiment of the present disclosure;

FIG. 1d is a flowchart of a beam indication method provided by another embodiment of the present disclosure;

FIG. 1e is a flowchart of a beam indication method provided by another embodiment of the present disclosure;

FIG. 1f is a flowchart of a beam indication method provided by another embodiment of the present disclosure;

FIG. 2a is a flowchart of a beam indication method provided by an embodiment of the present disclosure;

FIG. 2b is a flowchart of a beam indication method provided by another embodiment of the present disclosure;

FIG. 2c is a flowchart of a beam indication method provided by yet another embodiment of the present disclosure;

FIG. 2d is a flowchart of a beam indication method provided by another embodiment of the present disclosure;

FIG. 2e is a flowchart of a beam indication method provided by another embodiment of the present disclosure;

FIG. 3a is a flowchart of a beam indication method provided by an embodiment of the present disclosure;

FIG. 3b is a flowchart of a beam indication method provided by another embodiment of the present disclosure;

FIG. 3c is a flowchart of a beam indication method provided by yet another embodiment of the present disclosure;

FIG. 3d is a flowchart of a beam indication method provided by another embodiment of the present disclosure;

FIG. 3e is a flowchart of a beam indication method provided by another embodiment of the present disclosure;

FIG. 3f is a flowchart of a beam indication method provided by another embodiment of the present disclosure;

FIG. 4a is a flowchart of a beam indication method provided by an embodiment of the present disclosure;

FIG. 4b is a flowchart of a beam indication method provided by another embodiment of the present disclosure;

FIG. 4c is a flowchart of a beam indication method provided by yet another embodiment of the present disclosure;

FIG. 4d is a flowchart of a beam indication method provided by another embodiment of the present disclosure;

FIG. 4e is a flowchart of a beam indication method provided by another embodiment of the present disclosure;

FIG. 5 is a schematic structural diagram of a beam indication apparatus provided by an embodiment of the present disclosure;

FIG. 6 is a schematic structural diagram of a beam indication apparatus provided by another embodiment of the present disclosure;

FIG. 7 is a block diagram of a user device provided by an embodiment of the present disclosure;

FIG. 8 is a block diagram of a network side device provided by an embodiment of the present disclosure;

FIGS. 9-11 are schematic structural diagrams of a Media Access Control layer Random Access Response signaling provided in the present disclosure;

FIG. 12 is a schematic diagram of a field included in a UL Grant field provided by the present disclosure;

FIG. 13 is a schematic structural diagram of a time-frequency position arrangement of a DMRS on a symbol of a PDCCH provided by an embodiment of the present disclosure;

FIG. 14 shows diagram indicating a corresponding relationship between a time-frequency position arrangement of a DMRS on a symbol of a PDCCH and a beam provided by an embodiment of the present disclosure;

FIGS. 15-17 show diagrams indicating corresponding relationship between a time-frequency position arrangement of a DMRS on a symbol of a PDSCH and a beam provided by an embodiment of the present disclosure.

### DETAILED DESCRIPTION

Reference will now be made in detail to some embodiments of the present disclosure, examples of which are illustrated in the accompanying drawings. The following descriptions refer to the accompanying drawings in which the same numbers in different drawings represent the same or similar elements unless otherwise represented. The implementations set forth in the following descriptions of some embodiments do not represent all implementations consistent with embodiments of the present disclosure. Instead, they are merely examples of apparatuses and methods consistent with aspects related to the embodiments of the present disclosure as recited in the appended claims.

The terms used in the embodiments of the present disclosure are only for the purpose of describing specific embodiments and are not intended to limit the embodiments of the present disclosure. The singular forms of “a” and “the” used in the embodiments of the present disclosure and appended claims are also intended to include plural forms, unless the context clearly indicates other meanings. It should also be understood that the term “and/or” as used herein refers to and includes any or all possible combinations of one or more associated listed items.

It should be understood that although the terms first, second, and third may be used in the embodiments of the present disclosure to describe various information, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when”, “while” or “in response to determining”.

A beam indication method/apparatus/device and non-transitory storage medium provided by embodiments of the present disclosure will be described in detail with reference to the accompanying drawings. It should be noted that in all embodiments of the present disclosure, the explanation for the same parameters is the same. In order to make the present disclosure clearer, the same parameters will not be repeatedly explained in different embodiments.

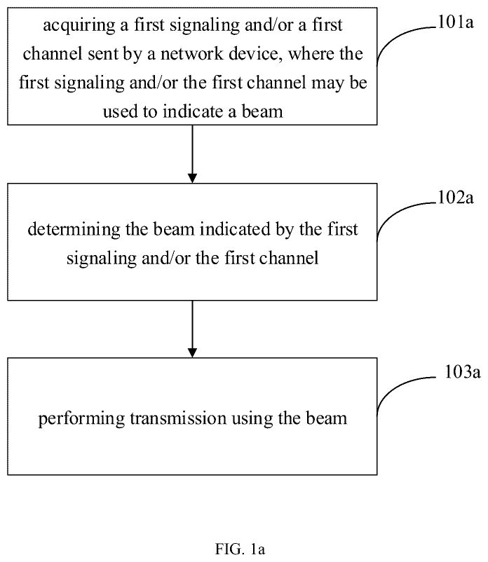

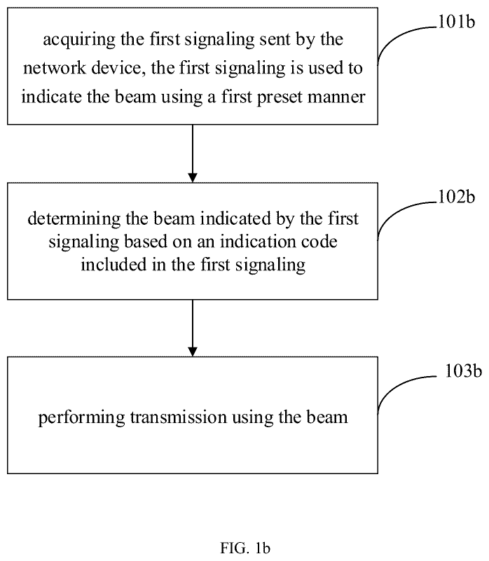

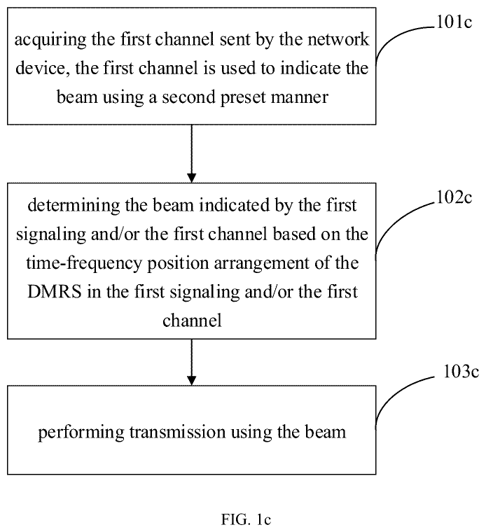

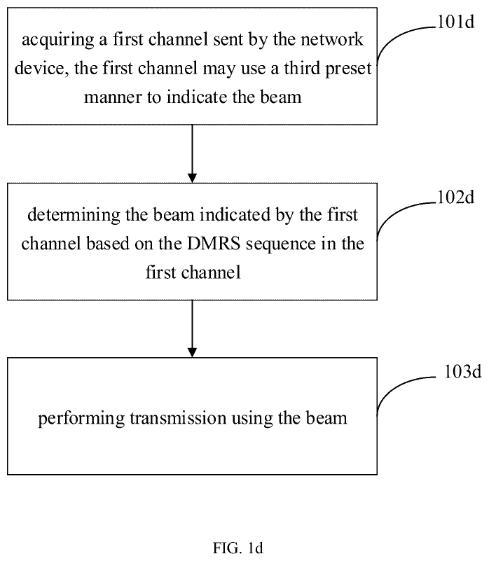

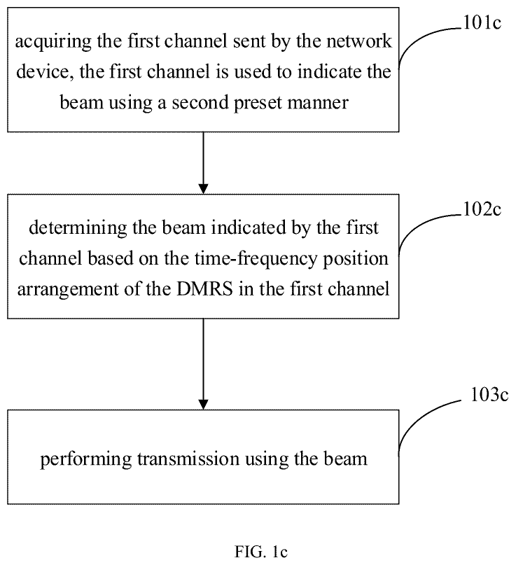

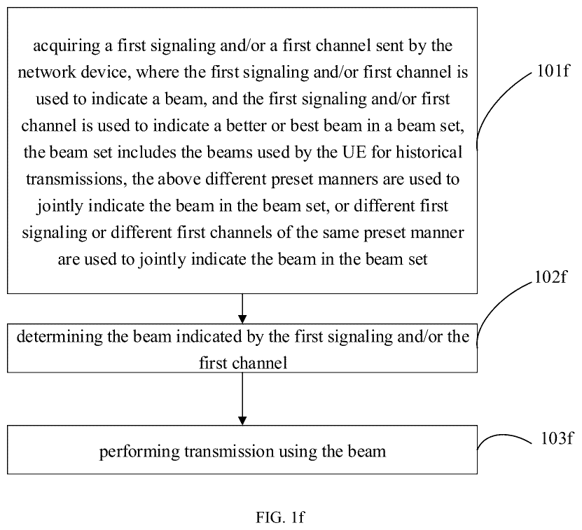

FIG. 1a is a flowchart of a beam indication method provided by an embodiment of the present disclosure, which is performed by a UE. As shown in FIG. 1a, the beam indication method may include the following steps 101a-103a:
in step 101a: a first signaling and/or a first channel sent by a network device is acquired, where the first signaling and/or the first channel may be used to indicate a beam used by the UE to perform transmission.

It should be explained that in the embodiments of the present disclosure, the UE may be a terminal device or a network device. The UE may be a device that provides speech and/or data connectivity for a user. The UE may communicate with one or more core networks by means of a radio access network (RAN), and the UE may be an Internet of Things terminal, for instance, a sensor device, a mobile telephone (or referred to as a “cellular” telephone), and a computer having an Internet of Things terminal, for instance, may be a stationary, portable, pocket-sized, hand-held, computer-built, or vehicle-mounted device, for instance, a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the UE may also be a vehicle-mounted device, for instance, a trip computer having a radio communication function, or a radio communication device externally connected to the trip computer. Alternatively, the UE may also be a roadside device, for instance, a street lamp, a signal lamp, another roadside device, etc., with the radio communication function.

In an embodiment of the present disclosure, the method may be applied to the random access process. For example, the method may be applied to two-step random access process and/or four step random access process. Furthermore, in an embodiment of the present disclosure, the method is applied to a four-step random access process as an example for the illustration as follows.

Furthermore, in an embodiment of the present disclosure, the first signaling and/or the first channel may be specifically used to indicate any beam in a beam set, such as indicating a better or a best beam in the beam set (such as a beam with a higher or highest receiving power). The beam set may include beams used by the UE for historical transmissions (i.e. historical transmission beams, such as the beams used by the UE when the UE historically sends PRACHs (Physical Random Access Channel)), and the best beam may be a beam with the highest receiving power among the beams that are historically sent by the UE to the network device.

Moreover, in an embodiment of the present disclosure, there may be various methods for indicating the beam by the first signaling and/or the first channel. The details of various beam indication methods will be described in detail in subsequent embodiments.

In step 102a: the beam indicated by the first signaling and/or the first channel is determined.

When the methods for indicating the beam by the first signaling in step 101a are different, the methods for determining the beam indicated by the first signaling and/or the first channel are also different. Moreover, this part of the content will be described in detail in subsequent embodiments.

In step 103a: transmission is performed using the beam.

In an embodiment of the present disclosure, when the UE determines the beam indicated by the network device through the first signaling and/or the first channel, the UE may directly communicate with the network device based on the beam indicated by the first signaling and/or the first channel in the subsequent transmission process, which may ensure the reliability of subsequent transmission. The transmission may be an uplink transmission.

Furthermore, in an embodiment of the present disclosure, the above-mentioned method for communicating with the network device based on the beam indicated by the first signaling and/or the first channel may include: when the UE subsequently needs to send uplink information (such as MSG3 and/or PUCCH (physical uplink control channel)) to the network device, the UE may, based on the QCL (Quasi Co Position) relationship, send the uplink information to the network device by using the same beam as the beam indicated by the first signaling and/or the first channel. When the UE subsequently needs to receive downlink information (such as at least one of MSG4, PDCCH (physical downlink control channel), or PDSCH (physical downlink shared channel)) sent by the network device, the UE may, based on the channel reciprocity, receive the downlink information by using a downlink beam having beam reciprocity with a transmission beam indicated by the first signaling and/or the first channel.

In all embodiments of the present disclosure, the first signaling and/or the first channel may be used to indicate the beam used by the terminal device to perform transmission; the correspondence between the first signaling and/or the first channel and the beam used by the terminal device to perform transmission may be determined based on a communication protocol, or may be indicated by the base station, or may be preset within the UE.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 1b is a flowchart of a beam indication method provided by an embodiment of the present disclosure, performed by a UE. As shown in FIG. 1b, the beam indication method may include the following steps 101b-103b:

in step 101b: the first signaling sent by the network device is acquired, the first signaling is used to indicate the beam using a first preset manner; where the first preset manner is to indicate the beam through an indication code, and different beams are used to indicate different indication codes.

In an embodiment of the present disclosure, the first preset manner may include: indicating the beam by using an indication code included in the first signaling, where the indication code includes N bits, N is a positive integer, and different indication codes indicate different beams.

Specifically, in an embodiment of the present disclosure, each beam in a beam set corresponds to a bit value. When the first signaling needs to indicate a certain beam, an indication code included in the first signaling may be set to a bit value of the beam to be indicated.

For example, in an embodiment of the present disclosure, it is assumed that the above-mentioned beam set includes three beams, namely beam 1, beam 2, and beam 3, where the bit value corresponding to beam 1 is 001, the bit value corresponding to beam 2 is 010, and the bit value corresponding to beam 3 is 100. If the first signaling needs to indicate the beam 1, the indication code included in the first signaling may be 001.

Furthermore, in an embodiment of the present disclosure, a carrying position of the first signaling may include at least one of the following:
a reserved field of a DCI (Downlink Control Information) signaling for scheduling MSG2;
a reserved field of a MAC RAR (Media Access Control Random access response, Media Access Control layer Random Access Response) of MSG2;
a newly-added byte(s) in an MAC RAR of MSG2; (for example, the newly-added bytes may include 8 bits);
an existing field in an UL Grant (Uplink Grant) field of an MAC RAR of MSG2; or a newly-added field in a UL Grant field of an MAC RAR of MSG2.

In an embodiment of the present disclosure, the existing field in the UL Grant field include at least one of the following:
a TPC (Transmit Power Control) field;
a CSI (Channel State Information) request field; or
an MCS (Modulation and Coding Scheme) field.

Specifically, each of the carrying positions mentioned above will be introduced in detail.

In an embodiment of the present disclosure, the above reserved field of a DCI signaling for scheduling MSG2 may be a reserved field in DCI format 1_0 used for scheduling MSG2. Specifically, in the embodiment of the present disclosure, the DCI format 1_0 used for scheduling MSG2 may be scrambled using RA-RNTI (Random Access-Radio Network Temporary Identity), and the reserved field in the DCI format 1_0 used for scheduling MSG2 has a total of 16 reserved fields, where some or all of the 16 reserved fields may be used to indicate the beam.

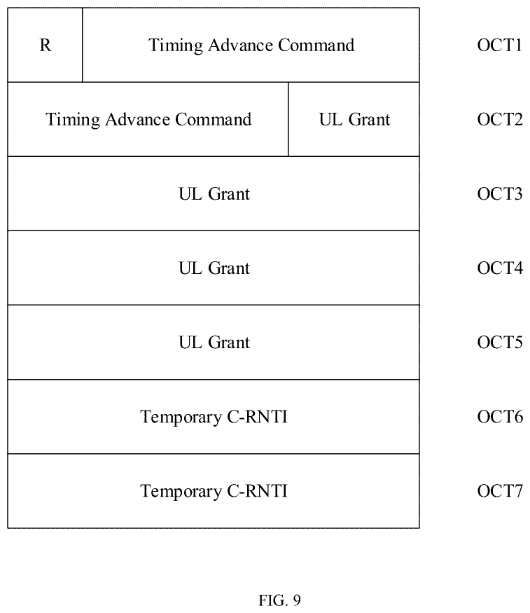

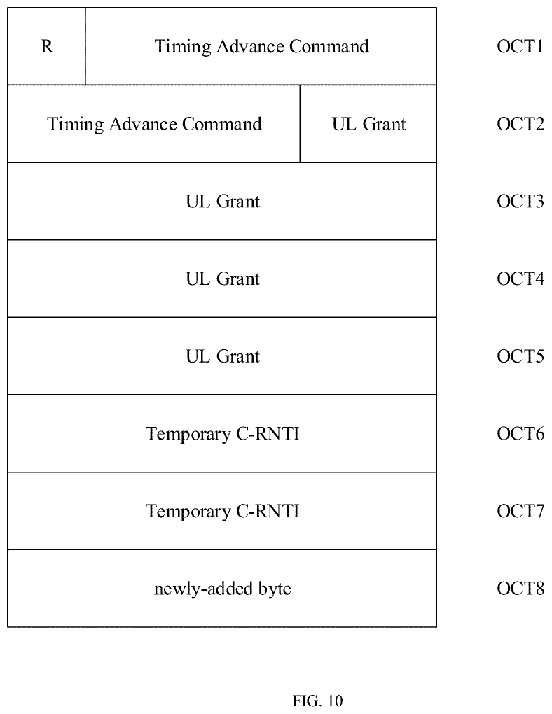

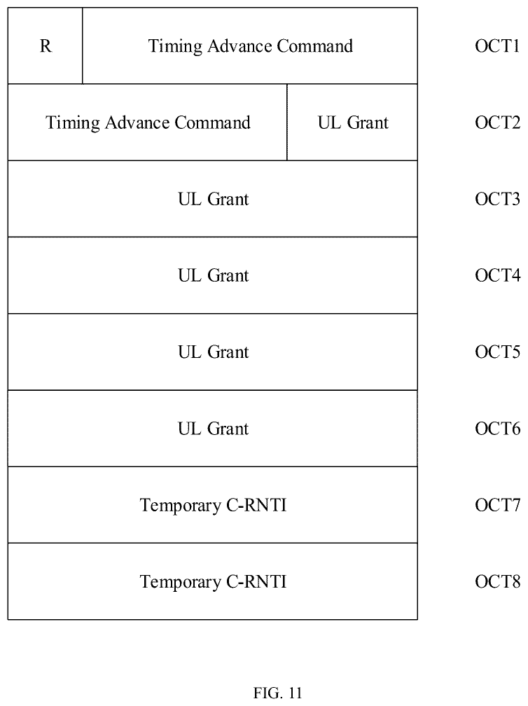

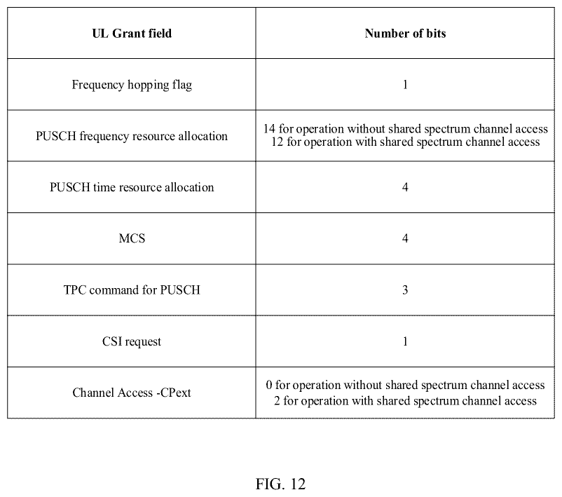

In an embodiment of the present disclosure, FIGS. 9-11 are schematic structural diagrams of a Media Access Control layer Random Access Response signaling of MSG2 provided in the present disclosure, and FIG. 12 is a schematic diagram of a field included in a UL Grant field provided in the present disclosure, where the reserved field of the MAC RAR of MSG2 mentioned above may be the “R” position in OCT1 in FIG. 9; the newly-added byte(s) in the MAC RAR of MSG2 mentioned above may be OCT8 in FIG. 10; the existing field in the UL Grant field in the MAC RAR of MSG2 may be at least one of TPC field, CSI request field, or MCS field in the UL Grant field of OCT2-OCT5 in FIG. 9. referring to FIG. 12, the TPC field in the UL Grant field is 3 bits, the CSI request field in the UL Grant field is 1 bit, and the MCS field in the UL Grant field is 4 bits. Based on this, some or all of the bits in the TPC field, CSI request field, and MCS field may be used to indicate the beam. The newly-added field in the UL Grant field of the MAC RAR of MSG2 mentioned above may be some or all of the fields included in OCT6 in FIG. 11.

In addition, it should be noted that in an embodiment of the present disclosure, when the number of bits of the bit value corresponding to the beam is relatively large, for example, greater than the number of bits of the indication code included in one first signaling, the field of one carrying position may not be able to successfully indicate the beam. Thus, in an embodiment of the present disclosure, acquiring the first signaling sent by the network device in step 101b may include: acquiring at least one first signaling sent by the network device, where carrying positions of different first signalings are different or the same, and different carrying positions indicate some or all of bit values corresponding to the beam, and bit values indicated by all carrying positions are combined together to form an entire bit value of the beam for indicating the beam.

For example, in an embodiment of the present disclosure, assuming that the number of bits of the bit value corresponding to the beam is 7 bits, when the bit value of the beam to be indicated is 0000001, the UE may acquire the DCI signaling and the MAC RAR signaling sent by the network device, where some or all of the reserved field of the DCI signaling is used to indicate the top four bits (i.e. 0000) of the bit value indicating the beam, and some or all of the bits in the TPC field of the MAC RAR signaling are used to indicate the last three bits (i.e. 001) of the bit value indicating the beam. Alternatively, the UE may acquire the DCI signaling and the MAC RAR signaling sent by the network device, where some or all of the reserved field of the DCI signaling is used to indicate the top four bits (i.e. 0000) of the bit value indicating the beam, and some or all of the bits in the TPC field of the MAC RAR signaling are used to indicate the last three bits (i.e. 001) of the bit value indicating the beam.

In step 102b: the beam indicated by the first signaling is determined based on the indication code included in the first signaling.

Specifically, in an embodiment of the present disclosure, when the carrying position of the first signaling is the DCI signaling, the UE may determine the indication code in the first signaling by parsing the reserved field of the DCI signaling, so as to determine the corresponding indication beam.

It should be noted that in an embodiment of the present disclosure, not every DCI signaling is used to indicate the beam. Thus, after acquiring the DCI signaling, the UE needs to determine whether to parse the reserved field of the DCI signaling to determine the beam indicated by the DCI signaling. Specifically, in an embodiment of the present disclosure, when the UE is a UE under R17 version, the UE always does not parse the reserved field of the DCI signaling. In another embodiment of the present disclosure, when the UE is a UE under R18 version, if the UE is located at an edge of a cell or has poor signal quality or performs a plurality of repeated transmissions of PRACH, the UE parses the reserved field of the DCI signaling to determine the indication code for indicating the beam in the first signaling; if the UE is located in the center of the cell or does not perform the plurality of repeated transmissions of PRACH, the UE does not parse the reserved field of the DCI signaling.

In another embodiment of the present disclosure, when the carrying position of the first signaling is the MAC RAR of MSG2, the UE may determine the indication code in the first signaling by parsing the MAC RAR, so as to determine the corresponding indication beam.

It should be noted that in an embodiment of the present disclosure, for the MAC RAR carrying the first signaling, the MAC RAR may include 7 bytes (as shown in FIG. 9 above), and the MAC RAR may also include 8 bytes (as shown in FIGS. 10 and 11 above). Since manners for parsing the MAC RARs with different bytes are not the same, it is necessary to determine the specific parsing manner of the UE for the MAC RAR carrying the first signaling.

Specifically, in an embodiment of the present disclosure, when the UE is a UE under R17 version, the UE always uses a 7-byte corresponding parsing manner to parse the MAC RAR carrying the first signaling (such as parsing the reserved field of the MAC RAR and/or the UL Grant field of the MAC RAR) to determine the indication code in the first signaling.

In another embodiment of the present disclosure, when the UE is a UE under R18 version, if the UE is located at the edge of a cell or has poor signal quality or performs a plurality of repeated transmissions of PRACH, the UE uses an 8-byte corresponding parsing manner to parse the MAC RAR carrying the first signaling to determine the indication code in the first signal; if the UE is located in the center of the cell or does not perform the plurality of repeated transmissions of PRACH, the UE uses a 7-byte corresponding parsing manner to parse the MAC RAR carrying the first signaling to determine the indication code in the first signaling.

In addition, it should be noted that in an embodiment of the present disclosure, not every MAC RAR is used to indicate the beam. Thus, when the UE parses the MAC RAR, it is also necessary to determine whether the MAC RAR needs to be parsed according to the concept that “the field in the MAC RAR (such as the reserved field of the MAC RAR, the newly-added byte(s) in the MAC RAR, the TPC field in the UL Grant field of the MAC RAR, the CSI request field in the UL Grant field of the MAC RAR, the MCS field in the UL Grant field of the MAC RAR, and the newly-added field in the UL Grant field of the MAC RAR) is used to indicate the beam”.

Specifically, in an embodiment of the present disclosure, when the UE is a UE under R17 version, the UE always parses the MAC RAR not according to the concept that “the field in the MAC RAR is used to indicate beam”. In another embodiment of the present disclosure, when the UE is a UE under R18 version, if the UE is located at the edge of the cell or has poor signal quality or performs a plurality of repeated transmissions of PRACH, the UE parses the MAC RAR according to the concept that “the field in the MAC RAR is used to indicate beam” to determine the first signaling carried in the field of the MAC RAR for indicating the beam; if the UE is located in the center of the cell or does not perform the plurality of repeated transmissions of PRACH, the UE parses the MAC RAR not according to the concept that “the field in the MAC RAR is used to indicate beam”.

Furthermore, in an embodiment of the present disclosure, after the UE parses the DCI signaling and/or the MAC RAR to obtain the indication code in the first signaling, the beam corresponding to the bit value and the indication code may be directly determined as the beam indicated by the first signaling.

In step 103b: transmission is performed using the beam.

For the detailed introduction of step 103b, reference may be made to the above-mentioned embodiments, and details will be not repeated here in the embodiments of the present disclosure.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 1c is a flowchart of a beam indication method provided by an embodiment of the present disclosure, performed by a UE. As shown in FIG. 1c, the beam indication method may include the following steps 101c-103c:

in step 101c: the first channel sent by the network device is acquired, the first channel is used to indicate the beam using a second preset manner; the second preset manner is to indicate the beam through a time-frequency position arrangement (i.e. time-frequency resource location) of a DMRS (Demodulation Reference Scheme, Demodulation Reference Signal); different DMRS time-frequency position arrangements indicate different beams.

In an embodiment of the present disclosure, the second preset manner may include: indicating the beam by using a time-frequency position arrangement of a DMRS (Demodulation

Reference Scheme, Demodulation Reference Signal) in the first channel, where different time-frequency position arrangements indicate different beams.

In an embodiment of the present disclosure, the first channel may include at least one of the following:
a PDCCH for scheduling MSG2; or
a PDSCH for carrying MSG2.

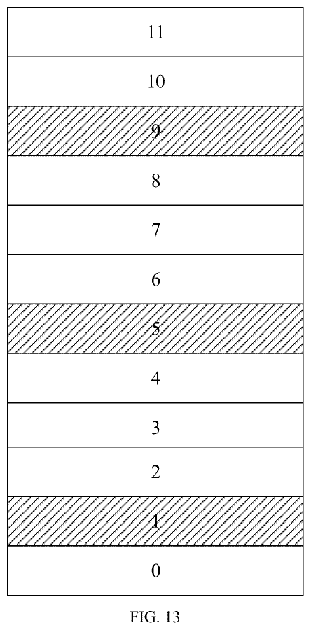

It should be noted that in an embodiment of the present disclosure, a symbol of the first channel may be carried with the DMRS. FIG. 13 is a schematic structural diagram of a time-frequency position arrangement of a DMRS on a symbol of a PDCCH channel provided by an embodiment of the present disclosure. As shown in FIG. 13, in a frequency domain, each RB (Resource Block) of one symbol may include 12 subcarriers, namely subcarrier #0 to subcarrier #11 in FIG. 13, where the DMRS may be located at three positions of subcarriers #1, #5, and #9 of each RB or symbol.

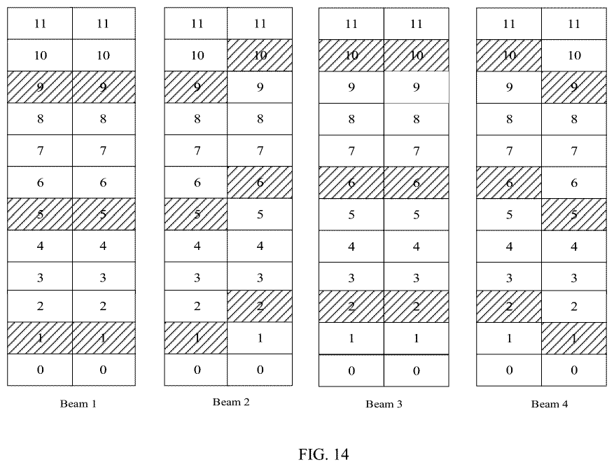

Based on this, in an embodiment of the present disclosure, different beams may be indicated by arranging the time-frequency position arrangement of the DMRS on the symbol in the PDCCH differently. FIG. 14 shows diagram indicating a corresponding relationship between a time-frequency position arrangement of a DMRS, i.e., DMRS Pattern (DMRS time-frequency position pattern) on a symbol of a PDCCH and a beam provided by an embodiment of the present disclosure. As shown in FIG. 14, taking the two symbol PDCCH as an example, when each of the time-frequency position arrangements of the DMRS on the first and second symbols of the PDCCH channel is: subcarrier #1, subcarrier #5, and subcarrier #9, the DMRS Pattern may be used to indicate beam 1; when the time-frequency position arrangement of the DMRS on the first symbol of the PDCCH channel is: subcarrier #1, subcarrier #5, subcarrier #9, and the time-frequency position arrangement of the DMRS on the second symbol is on the three positions: subcarrier #2, subcarrier #6, subcarrier #10, the DMRS Pattern may be used to indicate beam 2; when each of the time-frequency position arrangements of the DMRS on the first and second symbols is: subcarrier #2, subcarrier #6, subcarrier #10, the DMRS Pattern may be used to indicate beam 3; when the time-frequency position arrangement of the DMRS on the first symbol of the DCI signaling is: subcarrier #2, subcarrier #6, and subcarrier #10, and the time-frequency position arrangement of the DMRS on the second symbol is on the three positions: subcarrier #1, subcarrier #5, and subcarrier #9, the DMRS Pattern may be used to indicate beam 4.

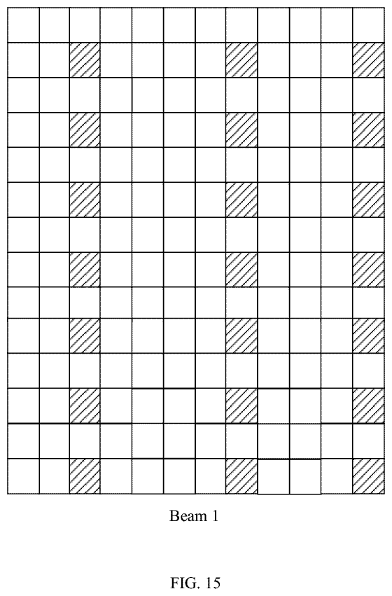

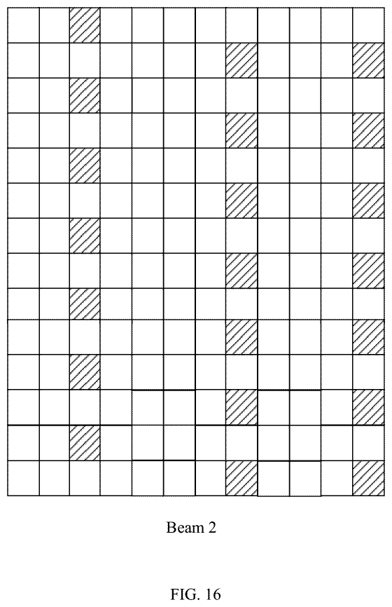

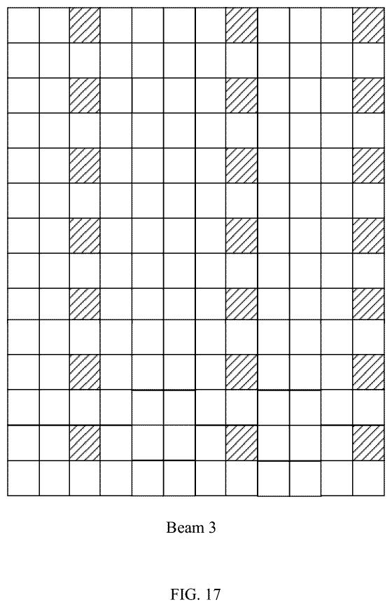

In addition, in an embodiment of the present disclosure, FIGS. 15-17 show diagrams indicating corresponding relationship between the time-frequency position arrangement, i.e. DMRS Pattern (DMRS time-frequency position pattern) of the DMRS on a symbol of a PDSCH and the beam provided by embodiments of the present disclosure. Taking a PDCCH with 14 symbols as an example, when the DMRS Pattern on the symbol of the PDCCH is FIG. 15, the DMRS Pattern may be used to indicate beam 1; when the DMRS Pattern on the symbol of the PDCCH is FIG. 16, the DMRS Pattern may be used to indicate beam 2, and when the DMRS Pattern on the symbol of the PDCCH is FIG. 17, the DMRS Pattern may be used to indicate beam 3.

In step 102c: the beam indicated by the first channel is determined based on the time-frequency position arrangement of the DMRS in the first channel.

In an embodiment of the present disclosure, the above determining the beam indicated by the first channel based on the time-frequency position arrangement of the first channel DMRS may include: the UE blind detects the DMRS in the first channel to determine the time-frequency position arrangement of the DMRS, and determines the beam corresponding to the time-frequency position arrangement of the DMRS in the first channel as the beam indicated by the first channel.

For example, in an embodiment of the present disclosure, as shown in FIG. 14, assuming that the time-frequency position arrangement of the DMRS in the first channel (such as the PDCCH) detected by the UE is: when each of the time-frequency position arrangements of the DMRS on the first symbol and the second symbol is: subcarriers #1, #5, and #9, the first channel may be used to indicate beam 1, and thus it may be determined that the beam indicated by the first channel is beam 1.

For example, in another embodiment of the present disclosure, assuming that the time-frequency position arrangement of the DMRS in the first channel (such as the PDSCH) detected by the UE is FIG. 15, the first channel may determine that the beam indicated by the first channel is beam 1.

Furthermore, it should be noted that for the first channel, not every first channel uses the DMRS Pattern to indicate the beam. Thus, after receiving each first channel, the UE should also determine the detection manner for the DMRS Pattern of the first channel. Specifically, in an embodiment of the present disclosure, when the UE is a UE under R17 version, the UE always detects the DMRS Pattern of the first channel using a conventional fixed DMRS detection manner, so as to subsequently perform the channel estimation based on the detected content. In another embodiment of the present disclosure, when the UE is a UE under the R18 version, if the UE is located at the edge of a cell or has poor signal quality or performs a plurality of repeated transmissions of PRACH, the UE may perform the blind detection on the DMRS in the first channel using a plurality of DMRS detection manners, and determine the DMRS Pattern in the first channel to further determine the beam indicated by the first channel; if the UE is located in the center of the cell or does not perform the plurality of repeated transmissions of PRACH, the UE uses a conventional fixed DMRS detection manner to detect the DMRS Pattern of the first channel, so as to subsequently perform the channel estimation based on the detected content.

In step 103c: transmission is performed using the beam.

For the detailed introduction of step 103c, reference may be made to the above-mentioned embodiments, and details will be not repeated here in the embodiments of the present disclosure.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel, and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 1d is a flowchart of a beam indication method provided by an embodiment of the present disclosure, performed by a UE. As shown in FIG. 1d, the beam indication method may include the following steps 101d-103d:

In step 101d: a first channel sent by the network device is acquired, the first channel may use a third preset manner to indicate the beam; the third preset manner is to indicate the beam through a DMRS sequence in the first channel; where different DMRS sequences are used to indicate different beams.

In an embodiment of the present disclosure, the third preset manner may include: indicating the beam by using the DMRS sequence in the first channel, where different DMRS sequences are used to indicate different beams.

In an embodiment of the present disclosure, the first channel may include at least one of the following:
a PDCCH for scheduling MSG2; or
a PDSCH for carrying MSG2.

In step 102d: the beam indicated by the first channel is determined based on the DMRS sequence in the first channel.

In an embodiment of the present disclosure, the method for the UE to determine the beam indicated by the first channel based on the DMRS sequence in the first channel may include: the UE first determines at least one scrambling ID (Identity, serial number), i.e., Scrambling ID, that is pre-configured by the network device, and the DMRS sequence generated by each scrambling ID may correspond to one beam. The scrambling ID may be configured by the network device through RMSI (Remaining Minimum System Information), and then the UE generates the first DMRS sequence based on each scrambling ID, where different first DMRS sequences correspond to different beams. The UE uses the correlation between each first DMRS sequence and the DMRS sequence in the first channel to determine a first DMRS sequence with the highest correlation with the DMRS sequence in the first channel from the plurality of first DMRS sequences, and determines the beam corresponding to the first DMRS sequence with the highest correlation as the beam indicated by the first channel.

Furthermore, it should be noted that for the first channel, not every first channel uses DMRS sequence to indicate the beam. Thus, after receiving each first channel, the UE should also determine the detection manner for the DMRS sequence of the first channel. Specifically, in an embodiment of the present disclosure, when the UE is a UE under R17 version, the UE always detects the DMRS sequence of the first channel using a conventional fixed DMRS detection manner, so as to subsequently perform the channel estimation based on the detected content. In another embodiment of the present disclosure, when the UE is a UE under the R18 version, if the UE is located at the edge of a cell or has poor signal quality or performs a plurality of repeated transmissions of PRACH, the UE may perform the blind detection on the DMRS in the first channel using a plurality of DMRS detection manners, and determine the DMRS sequence in the first channel to further determine the beam indicated by the first channel; if the UE is located in the center of the cell or does not perform the plurality of repeated transmissions of PRACH, the UE uses a conventional fixed DMRS detection manner to detect the DMRS sequence of the first channel, so as to subsequently perform the channel estimation based on the detected content.

In step 103d: transmission is performed using the beam.

For the detailed introduction of step 103d, reference may be made to the above-mentioned embodiments, and details will be not repeated here in the embodiments of the present disclosure.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel, and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 1e is a flowchart of a beam indication method provided by an embodiment of the present disclosure, performed by a UE. As shown in FIG. 1e, the beam indication method may include the following steps 101e-103e:

In step 101e: the first signaling sent by the network device is acquired, the first signaling may use a fourth preset manner to indicate the beam; the fourth preset manner is to use a scrambling sequence corresponding to the first signaling to indicate the beam, where different scrambling sequences correspond to different beams.

In an embodiment of the present disclosure, the fourth preset manner may include: indicating the beam by using a scrambling sequence corresponding to the first signaling, where the scrambling sequence may be a scrambling sequence corresponding to a RO (Random Access Occcasion) corresponding to any PRACH of PRACHs historically sent by the UE, and the scrambling sequence is used to indicate a beam used by the RO corresponding to the scrambling sequence. For example, in an embodiment of the present disclosure, the scrambling sequence may be a scrambling sequence corresponding to a RO used for the beam with the highest receiving power among the beams that are historically sent by the UE to the network device, and the scrambling sequence may be, for example, RA-RNTI.

In an embodiment of the present disclosure, the first signaling may include at least one of the following:
a DCI signaling for scheduling MSG2; or
a PDSCH for carrying MSG2.

It should be noted that in an embodiment of the present disclosure, the UE uses different beams to send PRACH to the network device on the RO corresponding to each corresponding scrambling sequence, to ensure the coverage performance of the signal. After the network device receives the PRACH sent by the UE on each RO, the network device determines the scrambling sequence corresponding to the RO that corresponds to the beam with the highest or a relatively higher receiving power. Afterwards, when the network device needs to send the first signaling to the UE, the network device may use the scrambling sequence to scramble the first signaling, such that the beam is indicated by the first signaling using the fourth preset manner.

Step 102e: the beam indicated by the first signaling is determined.

In an embodiment of the present disclosure, the method of determining the beam indicated by the first signaling based on the scrambling sequence corresponding to the first signaling may include:

step a: performing blind-decoding on the first signaling based on each scrambling sequence corresponding to each RO of each PRACH of the PRACHs historically sent by the UE.

For example, in an embodiment of the present disclosure, it is assumed that the UE has historically sent three PRACHs in history, where the RO for the first sent PRACH is RO-1, the corresponding scrambling sequence is scrambling sequence #1, the beam used under the RO-1 is beam #1, the RO for the second sent PRACH is RO-2, the corresponding scrambling sequence is scrambling sequence #2, the beam used under the RO-2 is beam #2, the RO for the third sent PRACH is RO-3, the corresponding scrambling sequence is scrambling sequence #3, and the beam used under the RO-3 is beam #3. After receiving the first signaling, the UE may use scrambling sequence #1, scrambling sequence #2, and scrambling sequence #3 respectively to perform the blind-decoding on the first signaling.

Step b: determining a scrambling sequence successfully decoding the first signaling (for example, a scrambling sequence that successfully performs CRC (Cyclic Redundancy Check) on the first signaling).

Step c: determining a beam used by an RO corresponding to the successfully-decoding scrambling sequence as the beam indicated by the first signaling.

For example, assuming that in above step b, the scrambling sequence #2 is determined as the scrambling sequence that successfully decodes the first signaling, it may be determined that the beam indicated by the first signaling is the beam #2 used by the RO-2 corresponding to scrambling sequence #2.

In step 103e: transmission is performed by using the beam.

For the detailed introduction of step 103e, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

Referring to the embodiments corresponding to FIGS. 1b to 1e mentioned above, it may be seen that in the embodiments of the present disclosure, the first preset manner, the second preset manner, the third preset manner, and the fourth preset manner may be configured to respectively indicate the beam. Furthermore, in an embodiment of the present disclosure, the above-mentioned preset manners may also be configured to jointly indicate the beam. Based on this, FIG. 1f is a flowchart of a beam indication method provided by an embodiment of the present disclosure, performed by a UE. As shown in FIG. 1f, the beam indication method may include the following steps 101f-103f:

in step 101f: a first signaling and/or a first channel sent by the network device is acquired, where the first signaling and/or first channel is used to indicate a beam used by the UE for transmission, and the first signaling and/or first channel is used to indicate a better or best beam in a beam set (such as the beam with a higher or highest receiving power), and the beam set includes the beams used by the UE for historical transmissions;
in response to that two or more than two preset manners are provided, at least two of the preset manners are configured to jointly indicate the beam in the beam set;
   or,
in response to that more than two types of first signalings are included in the same preset manner, the network device jointly indicates the beam in the beam set using different first signalings in the same preset manner;
   or,
in response to that more than two types of first channels are included in the same preset manner, the network device jointly indicates a beam in the beam set using different first channels in the same preset manner.

It should be noted that in an embodiment of the present disclosure, if the number of beams included in the beam set is greater than the number of beams that may be indicated by any preset manner, it is necessary to use the same or different preset manners to jointly indicate the beam in the beam set.

Specifically, in an embodiment of the present disclosure, assuming that a certain preset manner may only indicate 8 beams (for example, the indication code used to indicate the beam in the first preset manner includes 3 bits, or the first channel used to indicate the beam in the second preset manner includes 3 symbols), however, there are 10 beams in the beam set required to be indicated, the first preset manner cannot successfully indicate each beam in the beam set. Thus, different channels or different signaling in the same preset manner may be used to jointly indicate the beams. For example, taking the second preset manner as an example, the method of using different channels to jointly indicate the beams may be as follows: assuming that there are four DMRS patterns in the PDCCH, namely PDCCH DMRS pattern #0-PDCCH DMRS pattern #3, and assuming that there are two DMRS patterns in the PDSCH, namely PDSCH DMRS pattern #4 and PDSCH DMRS pattern #5, the beam 0 may be indicated by using (PDCCH DMRS pattern #0, PDSCH DMRS pattern #4), beam 1 may be indicated by using (PDCCH DMRS pattern #1, PDSCH DMRS pattern #4), beam 2 may be indicated by using (PDCCH DMRS Pattern #2, PDSCH DMRS pattern #4; beam 3 may be indicated by using (PDCCH DMRS Pattern #3, PDSCH DMRS pattern #4); beam 4 may be indicated by using (PDCCH DMRS pattern #0, PDSCH DMRS pattern #5). That is, the more than two types of first channels may be: parameters of more than two different channels; such as DMRS patterns of more than two different channels (such as PDSCH and PDCCH).

Alternatively, beam 0 may be indicated by using (PDSCH DMRS pattern #4, PDCCH DMRS Pattern #0); beam 1 may be indicated by using (PDSCH DMRS pattern #5, PDCCH DMRS Pattern #0); beam 2 may be indicated by using (PDSCH DMRS pattern #4, PDCCH DMRS Pattern #1); beam 3 may be indicated by using (PDSCH DMRS pattern #5, PDCCH DMRS Pattern #1); beam 4 may be indicated by using (PDSCH DMRS pattern #4, PDCCH DMRS Pattern #2); beam 5 may be indicated by using (PDSCH DMRS pattern #5, PDCCH DMRS Pattern #2).

Alternatively, taking the first preset manner as an example, different signalings or different carrying positions may be used to jointly indicate the beam. The method of jointly indicating the beam with different carrying positions may be as follows: assuming that the number of bits of the bit value corresponding to the beam is 7 bits, the UE may acquire the MAC RAR signaling sent by the network device, where top three bits (i.e., 000) of the bit value of the beam is determined and indicated based on some or all of the bits in the TPC field of the MAC RAR, and last four bits (i.e., 0001) of the bit value of the beam are indicated based on some or all of the bits in the MCS field of the MAC RAR, and thus different carrying positions of the MAC RAR may be combined to indicate the beam corresponding to the bit value of 0000001. Alternatively, the method that different signaling jointly indicate the beam may be as follows: the UE may acquire a DCI signaling and an MAC RAR signaling sent by the network device, where some or all reserved field of the DCI signaling is used to indicate the top four bits (i.e. 0000) of the bit value indicating the beam, and some or all bits in the TPC field of the MAC RAR signaling are used to indicate the last three bits (i.e. 001) of the bit value indicating the beam. That is, the more than two types of first signalings may be: bits in more than two different bit maps.

Alternatively, some or all of the bits in the TPC field may be used to indicate the high bits of the beam, while different DMRS sequences may be used to indicate the low bits of the beam. That is, different arrangements and combinations of the first signaling and the first channel may be used to jointly indicate the beam.

In addition, in another embodiment of the present disclosure, different preset manners may also jointly indicate the beam. Taking the second and third preset manners jointly indicate the beam as an example: assuming there are four DMRS patterns in the first channel, namely DMRS pattern #0-DMRS pattern #3, and two DMRS sequences, namely DMRS sequence #0 and DMRS sequence #1, beam 0 may be indicated by using (DMRS pattern #0, DMRS sequence #0); beam 1 may be indicated by using (DMRS pattern #1, DMRS sequence #0); beam 2 may be indicated by using (DMRS Pattern #2, DMRS sequence #0); beam 3 may be indicated by using (DMRS Pattern #3, DMRS sequence #0); beam 4 may be indicated by using (DMRS pattern #0, DMRS sequence #1). That is, different arrangements and combinations of the first signaling and the first channel may be used to jointly indicate the beam.

Alternatively, beam 0 may be indicated by using (DMRS Sequence #0, DMRS Pattern #0); beam 1 may be indicated by using (DMRS Sequence #1, DMRS Pattern #0); beam 2 may be indicated by using (DMRS Sequence #0, DMRS Pattern #1); beam 3 may be indicated by using (DMRS Sequence #1, DMRS Pattern #1); beam 4 may be indicated by using (DMRS Sequence #0, DMRS Pattern #2); beam 5 may be indicated by using (DMRS Sequence #1, DMRS Pattern #2). That is, different arrangements and combinations of the first signaling and the first channel may be used to jointly indicate the beam.

Moreover, in the embodiments of the present disclosure, the various situations mentioned above may also be implemented in combination.

In step 102f: the beam indicated by the first signaling and/or the first channel is determined.

In step 103f: transmission is performed using the beam.

For the detailed introduction of steps 102f-103f, reference may be made to the above-mentioned embodiments, and details will be not repeated here in the embodiments of the present disclosure.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

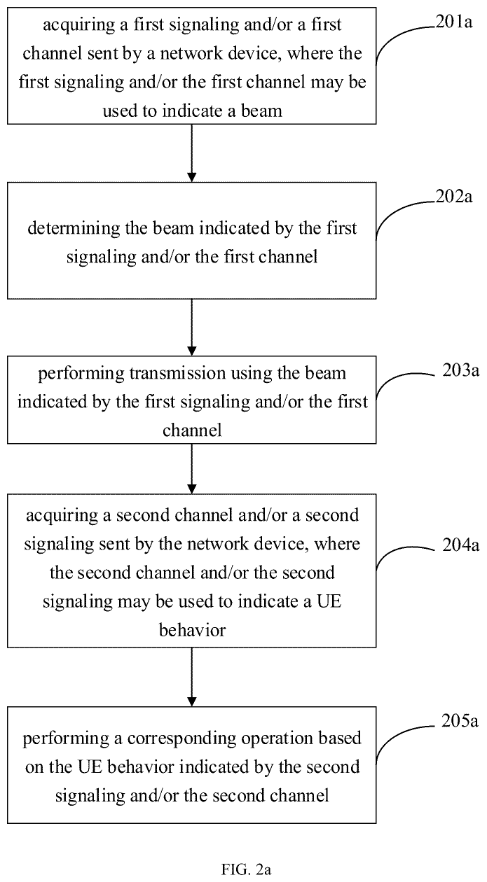

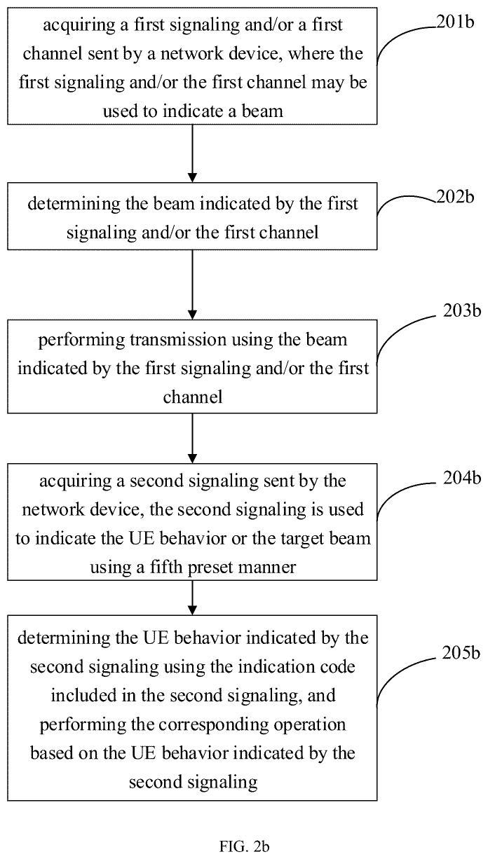

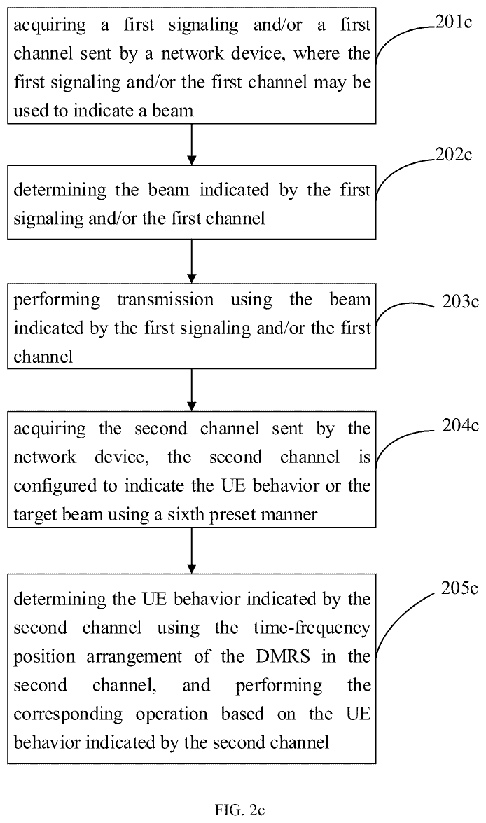

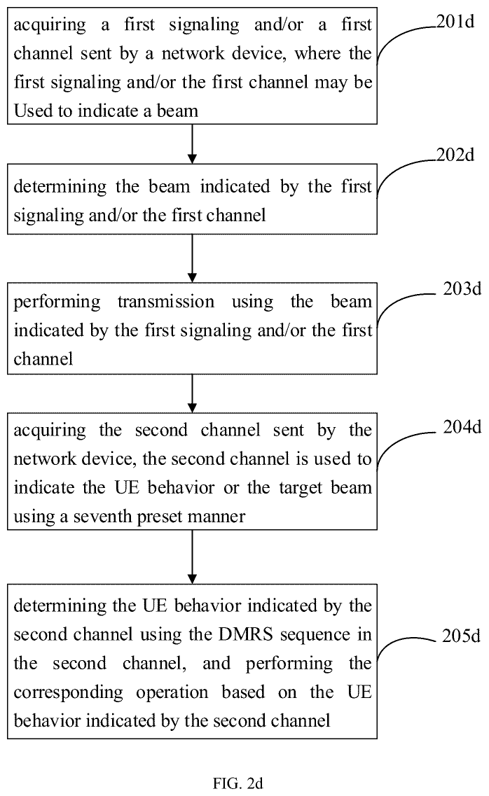

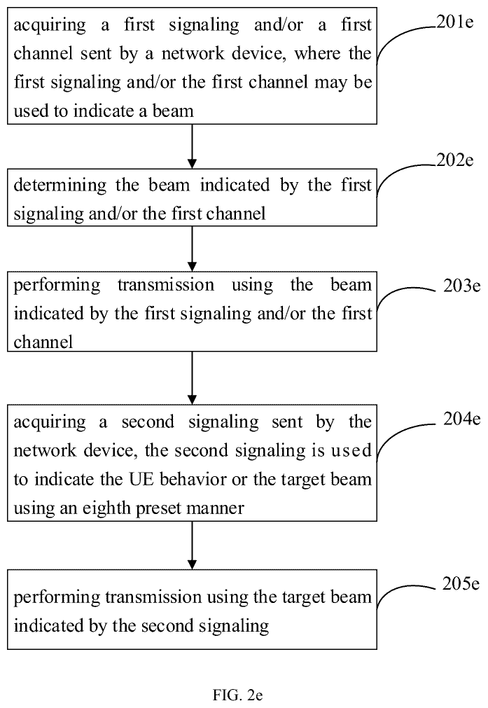

FIG. 2a is a flowchart of a beam indication method provided by an embodiment of the present disclosure, performed by a UE. As shown in FIG. 2a, the beam indication method may include the following steps 201a-205a:

in step 201a: a first signaling and/or a first channel sent by a network device is acquired, where the first signaling and/or the first channel may be used to indicate a beam used by the UE to perform transmission.

In step 202a: the beam indicated by the first signaling and/or the first channel is determined.

In step 203a: transmission is performed using the beam indicated by the first signaling and/or the first channel.

For the detailed introduction of steps 201a-203a, reference may be made to the above-mentioned embodiments, and details will be not repeated here in the embodiments of the present disclosure.

In step 204a: a second channel and/or a second signaling sent by the network device is acquired, where the second channel and/or the second signaling may be used to indicate a UE behavior.

In an embodiment of the present disclosure, the UE behavior may include any one of following: continuing to use the beam indicated by the first signaling and/or the first channel for transmission, randomly switching to a target beam for transmission, using a target beam for transmission when the second channel and/or the second signaling indicates the target beam, or autonomously re-determining, by the UE, a target beam for transmission.

In addition, in an embodiment of the present disclosure, there may be various manners for indicating the UE behavior or the target beam through the second signaling and/or the second channel, which will be described in detail in subsequent embodiments.

It should be noted that in an embodiment of the present disclosure, after the UE determines the beam indicated by the first signaling and/or the first channel, there may be a case where the transmission is not successful when using the beam indicated by the first signaling and/or the first channel for subsequent transmission. Thus, the second signaling and/or the second channel sent by the network device may be acquired, such that the UE may determine whether to continue using the beam indicated by the first signaling and/or the first channel for transmission or switch to the target beam for transmission based on the UE behavior indicated by the second signaling and/or the second channel.

In step 205a: a corresponding operation is performed based on the UE behavior indicated by the second signaling and/or the second channel.

Specifically, in an embodiment of the present disclosure, performing the corresponding operation based on the UE behavior indicated by the second signaling and/or the second channel may include:

When the UE behavior indicated in the second signaling and/or the second channel is to continue using the beam indicated in the first signaling and/or the first channel for transmission, the corresponding operation performed by the UE is to continue using the previous beam indicated by the first signaling and/or the first channel for transmission.

When the UE behavior indicated in the second signaling and/or the second channel is to randomly switch to the target beam for transmission, the corresponding operation performed by the UE is to randomly switch to the target beam for transmission.

When a target beam is indicated in the second signaling and/or the second channel, the corresponding operation performed by the UE is to switch to the target beam for transmission.

When the UE behavior indicated in the second signaling and/or the second channel is that the UE autonomously re-determines the target beam for transmission, the corresponding operation performed by the UE is that the UE autonomously re-determines the target beam for transmission.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 2b is a flowchart of a beam indication method provided by an embodiment of the present disclosure, performed by a UE. As shown in FIG. 2b, the beam indication method may include the following steps 201b-205b:

in step 201b: a first signaling and/or a first channel sent by a network device is acquired, where the first signaling and/or the first channel may be used to indicate a beam used by the UE to perform transmission.

In step 202b: the beam indicated by the first signaling and/or the first channel is determined.

In step 203b: transmission is performed using the beam indicated by the first signaling and/or the first channel.

In step 204b: a second signaling sent by the network device is acquired, the second signaling is used to indicate the UE behavior or the target beam using a fifth preset manner.

The fifth preset manner may include: indicating the UE behavior or the target beam by using an indication code included in the second signaling, where the indication code includes N bits, N is a positive integer, and different indication codes indicate different UE behaviors or different target beams.

In an embodiment of the present disclosure, a carrying position of the second signaling includes at least one of following:
a reserved field of a DCI signaling for scheduling MSG3;
an existing field of a DCI signaling for scheduling MSG3; or
a newly-added field of a DCI signaling for scheduling MSG3.

In an embodiment of the present disclosure, the existing field of the DCI signaling for scheduling the MSG3 includes at least one of following:
a TPC field of the DCI signaling for scheduling the MSG3;
a HPN field of the DCI signaling for scheduling the MSG3; or
an MCS field of the DCI signaling for scheduling the MSG3.

Specifically, in an embodiment of the present disclosure, the DCI signaling for scheduling the MSG3 mentioned above may be DCI format 0-0 used to schedule the MSG3 for retransmission.

The fifth preset manner mentioned above is similar to the first preset manner mentioned above. For detailed introduction of the fifth preset manner, reference may be made to the above-mentioned embodiments, which will not be repeated herein.

In step 205b: the UE behavior indicated by the second signaling is determined using the indication code included in the second signaling, and the corresponding operation is performed based on the UE behavior indicated by the second signaling.

For the detailed introduction of steps 201b-205b, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 2c is a flowchart of a beam indication method provided by an embodiment of the present disclosure, performed by a UE. As shown in FIG. 2c, the beam indication method may include the following steps 201c-205c:

in step 201c: a first signaling and/or a first channel sent by a network device is acquired, where the first signaling and/or the first channel may be used to indicate a beam used by the UE to perform transmission.

In step 202c: the beam indicated by the first signaling and/or the first channel is determined.

In step 203c: transmission is performed using the beam indicated by the first signaling and/or the first channel.

In step 204c: the second channel sent by the network device is acquired, the second channel is used to indicate the UE behavior or the target beam using a sixth preset manner.

The sixth preset manner includes: indicating the UE behavior or the target beam by using a time-frequency position arrangement of a DMRS in the second channel, where different time-frequency position arrangements indicate different UE behaviors or different target beams.

The sixth preset manner mentioned above is similar to the second preset manner mentioned above. For detailed introduction of the sixth preset manner, reference may be made to the above-mentioned embodiments, which will not be repeated herein.

In step 205c: the UE behavior indicated by the second channel is determined using the time-frequency position arrangement of the DMRS in the second channel, and the corresponding operation is performed based on the UE behavior indicated by the second channel.

For the detailed introduction of steps 201c-205c, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 2d is a flowchart of a beam indication method provided by an embodiment of the present disclosure, performed by a UE. As shown in FIG. 2d, the beam indication method may include the following steps 201d-205d:

in step 201d: a first signaling and/or a first channel sent by a network device is acquired, where the first signaling and/or the first channel may be used to indicate a beam used by the UE to perform transmission.

In step 202d: the beam indicated by the first signaling and/or the first channel is determined.

In step 203d: transmission is performed using the beam indicated by the first signaling and/or the first channel.

In step 204d: the second channel sent by the network device is acquired, the second channel is used to indicate the UE behavior or the target beam using a seventh preset manner.

The seventh preset manner includes: indicating the beam by using a DMRS sequence in the second channel, where different DMRS sequences are used to indicate different UE behaviors or different target beams.

The seventh preset manner mentioned above is similar to the third preset manner mentioned above. For detailed introduction of the seventh preset manner, reference may be made to the above-mentioned embodiments, which will not be repeated herein.

In step 205d: the UE behavior indicated by the second channel is determined using the DMRS sequence in the second channel, and the corresponding operation is performed based on the UE behavior indicated by the second channel.

For the detailed introduction of steps 201d-205d, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 2e is a flowchart of a beam indication method provided by an embodiment of the present disclosure, performed by a UE. As shown in FIG. 2e, the beam indication method may include the following steps 201e-205e:
in step 201e: a first signaling and/or a first channel sent by a network device is acquired, where the first signaling and/or the first channel may be used to indicate a beam used by the UE to perform transmission.

In step 202e: the beam indicated by the first signaling and/or the first channel is determined.

In step 203e: transmission is performed using the beam indicated by the first signaling and/or the first channel.

In step 204e: a second signaling sent by the network device is acquired, the second signaling is used to indicate the UE behavior or the target beam using an eighth preset manner.

The eighth preset manner includes: indicating the beam by using a scrambling sequence corresponding to the second signaling, where the scrambling sequence is a scrambling sequence corresponding to an RO corresponding to any one of PRACHs historically sent by the UE, and the scrambling sequence is used to indicate a beam used by the RO corresponding to the scrambling sequence.

The eighth preset manner mentioned above is similar to the fourth preset manner mentioned above. For detailed introduction of the eighth preset manner, reference may be made to the above-mentioned embodiments, which will not be repeated herein.

In step 205e: transmission is performed using the target beam indicated by the second signaling.

For the detailed introduction of steps 201e-205e, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

Thus, referring to the embodiments corresponding to FIGS. 2b-2e mentioned above, it may be seen that the fifth preset manner, the sixth preset manner, the seventh preset manner, and the eighth preset manner may be used to indicate the beam respectively according to the embodiments of the present disclosure. Furthermore, in an embodiment of the present disclosure, the above-mentioned preset manners may also be combined to indicate the target beam or the UE behavior. The method that various preset manners are combined to indicate the target beam or the UE behavior may refer to the relevant introduction of the above embodiments in FIG. 1f, which is not repeated herein.

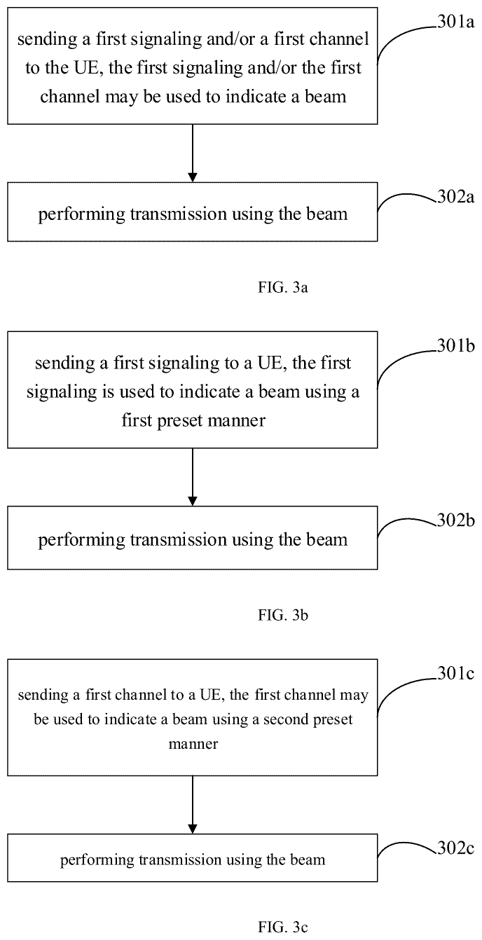

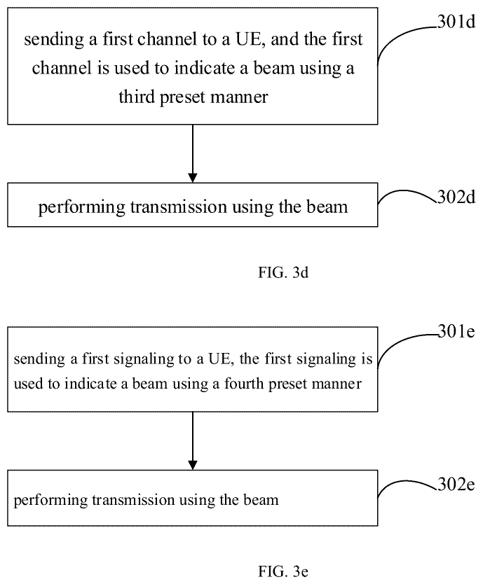

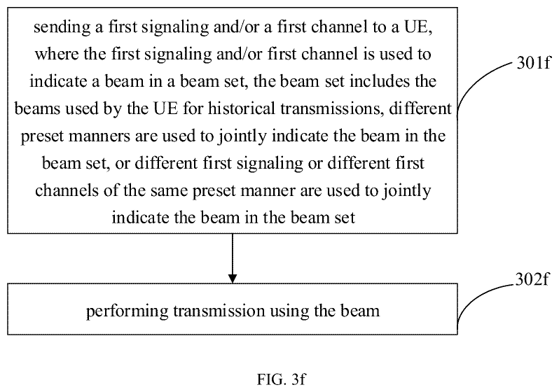

FIG. 3a is a flowchart of a beam indication method provided by an embodiment of the present disclosure, performed by a network device. As shown in FIG. 3a, the beam indication method may include the following steps 301a-302a:

in step 301a: a first signaling and/or a first channel is sent to the UE, the first signaling and/or the first channel may be used to indicate a beam used by the UE for transmission.

In step 302a: transmission is performed using the beam.

For the detailed introduction of steps 301a-302a, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 3b is a flowchart of a beam indication method provided by an embodiment of the present disclosure, performed by a network device. As shown in FIG. 3b, the beam indication method may include the following steps 301b-302b:

in step 301b: a first signaling is sent to a UE, the first signaling is used to indicate a beam used by the UE for transmission using a first preset manner.

In step 302b: transmission is performed using the beam.

For the detailed introduction of steps 301b-302b, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 3c is a flowchart of a beam indication method provided by an embodiment of the present disclosure, performed by a network device. As shown in FIG. 3c, the beam indication method may include the following steps 301c-302c:
in step 301c: a first channel is sent to a UE, the first channel is used to indicate a beam used by the UE for transmission using a second preset manner.

In step 302c: transmission is performed using the beam.

For the detailed introduction of steps 301c-302c, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 3d is a flowchart of a beam indication method provided by an embodiment of the present disclosure, performed by a network device. As shown in FIG. 3d, the beam indication method may include the following steps 301d-302d:
in step 301d: a first channel is sent to a UE, and the first channel is used to indicate a beam used by the UE for transmission using a third preset manner.

In step 302d: transmission is performed using the beam.

For the detailed introduction of steps 301d-302d, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 3e is a flowchart of a beam indication method provided by an embodiment of the present disclosure, performed by a network device. As shown in FIG. 3e, the beam indication method may include the following steps 301e-302e:
in step 301e: a first signaling is sent to a UE, the first signaling is used to indicate a beam used for transmission by the UE using a fourth preset manner.

In step 302e: transmission is performed using the beam.

For the detailed introduction of steps 301e-302e, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 3f is a flowchart of a beam indication method provided by an embodiment of the present disclosure, performed by a UE. As shown in FIG. 3f, the beam indication method may include the following steps 301f-302f:
in step 301f: a first signaling and/or a first channel is sent to a UE, where the first signaling and/or first channel is used to indicate a beam used by the UE for transmission, and the first signaling and/or first channel is used to indicate a better or best beam in a beam set (such as the beam with a higher or highest receiving power), and the beam set includes the beams used by the UE for historical transmissions;
in response to that two or more than two preset manners are provided, at least two of the preset manners are configured to jointly indicate the beam in the beam set;
   or,
in response to that more than two types of first signalings are included in the same preset manner, the network device jointly indicates the beam in the beam set using different first signalings in the same preset manner;
   or,
in response to that more than two types of first channels are included in the same preset manner, the network device jointly indicates a beam in the beam set using different first channels in the same preset manner.

In step 302f: transmission is performed using the beam.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

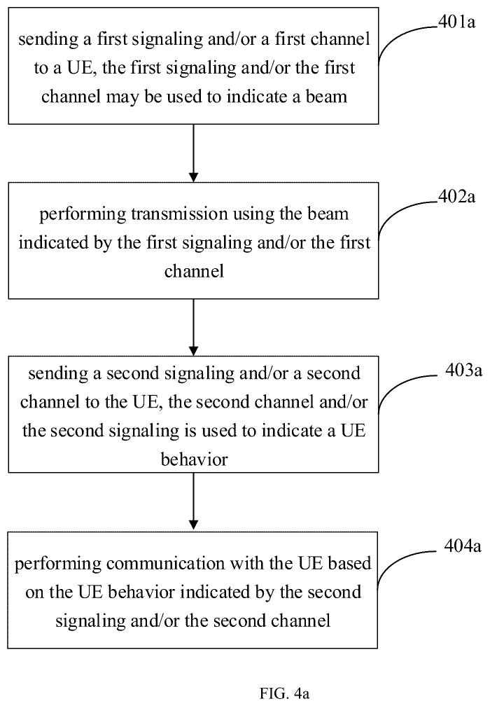

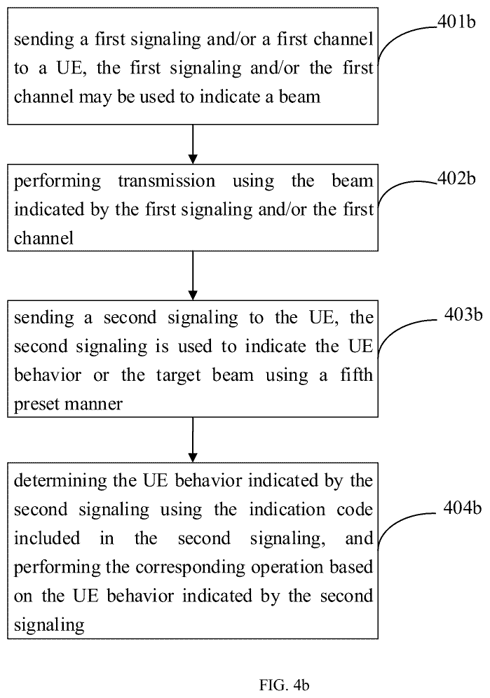

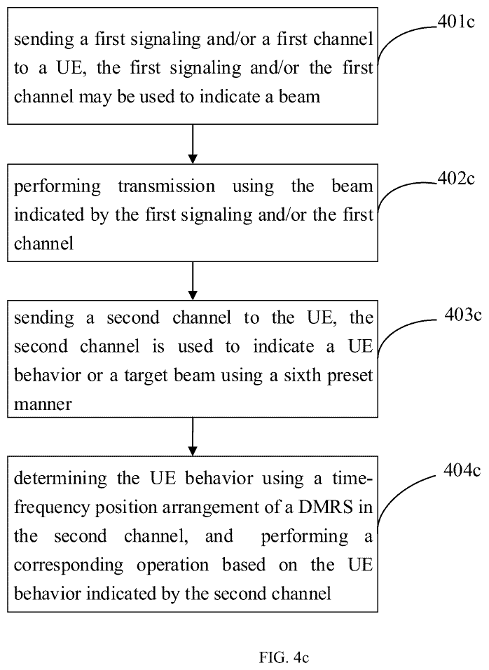

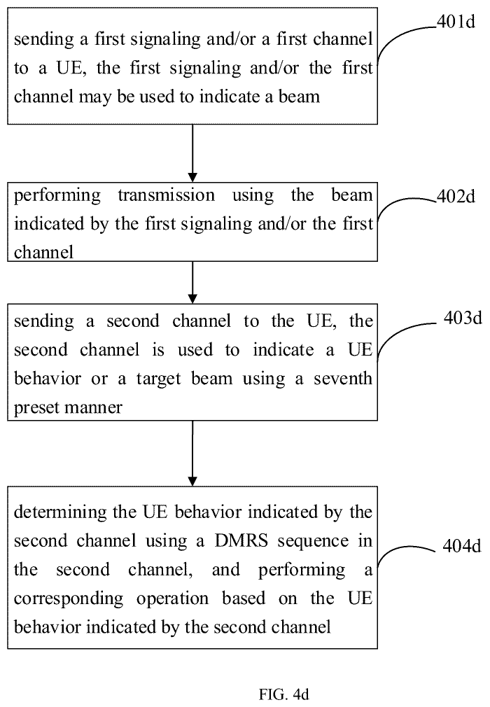

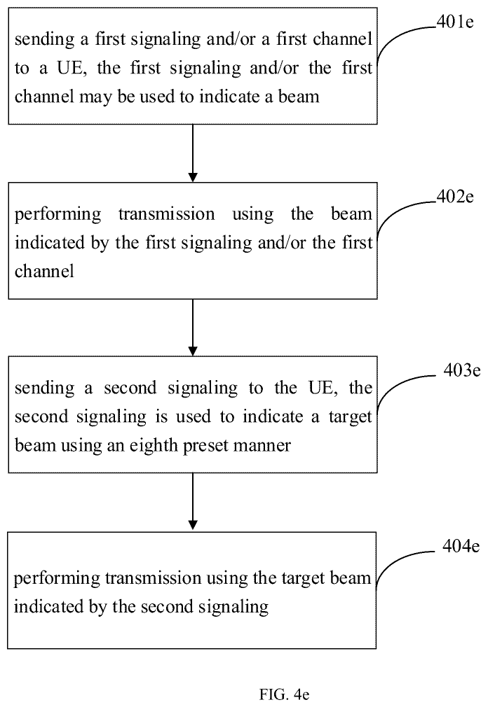

FIG. 4a is a flowchart of a beam indication method provided by an embodiment of the present disclosure, performed by a network device. As shown in FIG. 4a, the beam indication method may include the following steps 401a-404a:
in step 401a: a first signaling and/or a first channel is sent to a UE, the first signaling and/or the first channel may be used to indicate a beam used by the UE for transmission.

In step 402a: transmission is performed using the beam indicated by the first signaling and/or the first channel.

In step 403a: a second signaling and/or a second channel is sent to the UE, the second channel and/or the second signaling is used to indicate a UE behavior.

In step 404a: communication is performed with the UE based on the UE behavior indicated by the second signaling and/or the second channel.

For the detailed introduction of steps 401a-404a, reference may be made to the above-mentioned embodiments, and details will be not repeated here in the embodiments of the present disclosure.

In summary, in the beam indication method provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 4b is a flowchart of a beam indication method provided by an embodiment of the present disclosure, performed by a network device. As shown in FIG. 4b, the beam indication method may include the following steps 401b-404b:
in step 401b: a first signaling and/or a first channel is sent to a UE, the first signaling and/or the first channel may be used to indicate a beam used by the UE for transmission.

In step 402b: transmission is performed using the beam indicated by the first signaling and/or the first channel.

In step 403b: a second signaling is sent to the UE, the second signaling is used to indicate the UE behavior or the target beam using a fifth preset manner.

In step 404b: the UE behavior indicated by the second signaling is determined using the indication code included in the second signaling, and the corresponding operation is performed based on the UE behavior indicated by the second signaling.

For the detailed introduction of steps 401b-404b, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 4c is a flowchart of a beam indication method provided by an embodiment of the present disclosure, performed by a network device. As shown in FIG. 4c, the beam indication method may include the following steps 401c-404c:
in step 401c: a first signaling and/or a first channel is sent to a UE, the first signaling and/or the first channel may be used to indicate a beam used by the UE for transmission.

In step 402c: transmission is performed using the beam indicated by the first signaling and/or the first channel.

In step 403c: a second channel is sent to the UE, the second channel is used to indicate a UE behavior or a target beam using a sixth preset manner.

In step 404c: the UE behavior is indicated using a time-frequency position arrangement of a DMRS in the second channel, and a corresponding operation is performed based on the UE behavior indicated by the second channel.

For the detailed introduction of steps 401c-404c, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 4d is a flowchart of a beam indication method provided by an embodiment of the present disclosure, performed by a network device. As shown in FIG. 4d, the beam indication method may include the following steps 401d-404d:
in step 401d: a first signaling and/or a first channel is sent to a UE, the first signaling and/or the first channel may be used to indicate a beam used by the UE for transmission.

In step 402d: transmission is performed using the beam indicated by the first signaling and/or the first channel.

In step 403d: a second channel is sent to the UE, the second channel is used to indicate a UE behavior or a target beam using a seventh preset manner.

In step 404d: the UE behavior indicated by the second channel is determined using a DMRS sequence in the second channel, and a corresponding operation is performed based on the UE behavior indicated by the second channel.

For the detailed introduction of steps 401d-404d, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

FIG. 4e is a flowchart of a beam indication method provided by an embodiment of the present disclosure, performed by a network device. As shown in FIG. 4e, the beam indication method may include the following steps 401e-404e:
in step 401e: a first signaling and/or a first channel is sent to a UE, the first signaling and/or the first channel may be used to indicate a beam used by the UE for transmission.

In step 402e: transmission is performed using the beam indicated by the first signaling and/or the first channel.

In step 403e: a second signaling is sent to the UE, the second signaling is used to indicate a target beam using an eighth preset manner.

In step 404e: transmission is performed using the target beam indicated by the second signaling.

For the detailed introduction of steps 401e-404e, reference may be made to the above-mentioned embodiments, and details will be not repeated here in the embodiments of the present disclosure.

In summary, in the beam indication method provided by the embodiment of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission by using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

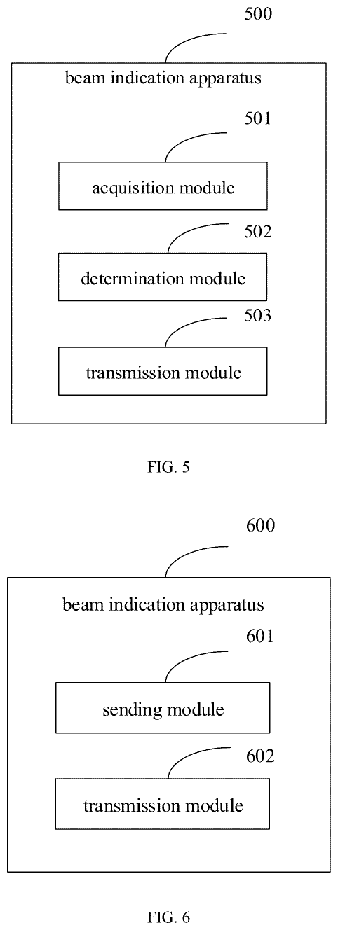

FIG. 5 is a schematic structural diagram of a beam indication apparatus provided by an embodiment of the present disclosure. As shown in FIG. 5, the apparatus may include:
an acquisition module, configured to acquire a first signaling and/or a first channel sent by a network device, where the first signaling and/or the first channel is used to indicate a beam;
a determination module, configured to determine the beam indicated by the first signaling and/or the first channel; and
a transmission module, configured to perform transmission using the beam.

In summary, in the beam indication apparatus provided by the embodiments of the present disclosure, the UE may acquire the first signaling and/or the first channel sent by the network device, the first signaling and/or the first channel may be used to indicate the beam. Afterwards, the UE may determine the beam indicated by the first signaling and/or the first channel and perform the transmission using the beam indicated by the first signaling and/or the first channel. It may be seen that in the embodiments of the present disclosure, the beam indication method is provided, which may be used to indicate a better or a best beam (such as the beam with a higher or highest receiving power), such that the subsequent UE may perform the transmission with the network device based on the indicated beam, thereby improving the reliability of data transmission and enhancing data coverage.

In some embodiments, in an embodiment of the present disclosure, the acquisition module is further configured to:
acquire the first signaling sent by the network device, where the first signaling is used to indicate the beam using a first preset manner.

The first preset manner includes: indicating the beam by using an indication code included in the first signaling, the indication code includes N bits, N is a positive integer, and different indication codes indicate different beams.

In some embodiments, in an embodiment of the present disclosure, a carrying position of the first signaling includes at least one of the following:
a reserved field of a DCI (Downlink Control Information) signaling for scheduling MSG2 (message, information);
a reserved field of a MAC (Media Access Control, Media Access Control layer) RAR (Random Access Response) of MSG2;
a newly-added byte(s) in an MAC RAR of MSG2;
an existing field in a UL Grant (Uplink Grant) information field of an MAC RAR of MSG2; or
a newly-added field in a UL Grant field of an MAC RAR of MSG2.

In some embodiments, in an embodiment of the present disclosure, the existing field of the UL Grant field include at least one of the following:
a TPC (Transmit Power Control) field;
a CSI (Channel State Information) request field;
an MCS (Modulation and Coding Scheme) field.

In some embodiments, in an embodiment of the present disclosure, the acquisition module is further configured to:
acquire the first channel sent by the network device, the first channel is used to indicate the beam using a second preset manner;
the second preset manner includes: indicating the beam used by the UE for transmission by using a time-frequency position arrangement of a DMRS (Demodulation Reference Scheme, Demodulation Reference Signal) in the first channel, where different time-frequency position arrangements indicate different beams.

In some embodiments, in an embodiment of the present disclosure, the acquisition module is further configured to:
acquire the first channel sent by the network device, the first channel is used to indicate the beam using a third preset manner;
the third preset manner includes: indicating the beam used by the UE for transmission by using a DMRS sequence in the first channel, where different DMRS sequences are used to indicate different beams.

In some embodiments, in an embodiment of the present disclosure, the first channel includes at least one of the following:
a PDCCH (Physical Downlink Control Channel) for scheduling MSG2; or
a PDSCH (Physical Downlink Shared Channel) for carrying MSG2.

In some embodiments, in an embodiment of the present disclosure, the acquisition module is further configured to:
acquire the first signaling sent by the network device, the first signaling is used to indicate a beam used by the UE for transmission using a fourth preset manner;
the fourth preset manner includes: indicating the beam by using a scrambling sequence corresponding to the first signaling, where the scrambling sequence is a scrambling sequence corresponding to a RO (Random Access Occcasion) corresponding to any one of PRACHs (random access channel) historically sent by the UE, and the scrambling sequence is used to indicate a beam used by the RO corresponding to the scrambling sequence

In some embodiments, in an embodiment of the present disclosure, the first signaling includes at least one of the following:
a DCI signaling for scheduling MSG2; or
a PDSCH (Physical Downlink Shared Channel) for carrying MSG2.

In some embodiments, in an embodiment of the present disclosure, the scrambling sequence is a RA-RNTI (Random-Radio Network Temporary Identity).

In some embodiments, in an embodiment of the present disclosure, the determination module is further configured to:
determine the beam indicated by the first signaling based on the indication code included in the first signaling.

In some embodiments, in an embodiment of the present disclosure, the determination module is further configured to:
determine the beam indicated by the first channel based on the time-frequency position arrangement of the DMRS in the first channel.

In some embodiments, in an embodiment of the present disclosure, the determination module is further configured to:
determine the beam indicated by the first channel based on the DMRS sequence in the first channel.

In some embodiments, in an embodiment of the present disclosure, the determination module is further configured to:
perform blind-decoding on the first signaling based on each scrambling sequence corresponding to each RO of each PRACH of the PRACHs historically sent by the UE;
determine a scrambling sequence successfully decoding the first signaling;
determine a beam used by an RO corresponding to the successfully-decoding scrambling sequence as the beam indicated by the first signaling.

In some embodiments, in an embodiment of the present disclosure, the first signaling and/or the first channel is used to indicate any beam in a beam set as the beam used by the UE for transmission, where the beam set includes the beams used by the UE for historical transmissions;
the different preset manners are configured to jointly indicate a beam in the beam set, or different first signalings or different first channels of the same preset manner are configured to jointly indicate a beam in the beam set.

In some embodiments, in an embodiment of the present disclosure, the first signaling and/or the first channel indicate the beam by indicating a bit value corresponding to the beam;
the acquisition module is further configured to:
acquire at least one first signaling and/or first channel sent by the network device, where carrying positions of different first signalings and/or different first channels are different or the same, different first signalings and/or different first channels indicate some or all of bit values corresponding to the beam, and bit values indicated by all first signalings and/or all first channels are combined to form an entire bit value of the beam for indicating the beam used by the UE for transmission.

In some embodiments, in an embodiment of the present disclosure, the apparatus is also configured to:
acquire a second signaling and/or a second channel sent by the network device, where the second signaling and/or the second channel is used to indicate a UE behavior, the UE behavior includes any one of the following: continuing to use the beam indicated by the first signaling and/or first channel for transmission, randomly switching to a target beam for transmission, using a target beam indicated by the second signaling and/or the second channel for transmission when the target beam is indicated by the second signaling and/or the second channel, and autonomously re-determining, by the UE, a target beam for transmission;
perform a corresponding operation based on the UE behavior indicated by the second signaling and/or the second channel.

In some embodiments, in an embodiment of the present disclosure, the apparatus is also configured to:
acquire the second signaling sent by the network device, the second signaling is used to indicate the UE behavior or the target beam using a fifth preset manner;
The fifth preset manner includes: indicating the UE behavior or the target beam by using an indication code included in the second signaling, where the indication code includes N bits, N is a positive integer, and different indication codes indicate different UE behaviors or different target beams.

In some embodiments, in an embodiment of the present disclosure, a carrying position of the second signaling includes at least one of the following:
a reserved field of a DCI signaling for scheduling MSG3;
an existing field of a DCI signaling for scheduling MSG3; or
a newly-added field of a DCI signaling for scheduling MSG3.

In some embodiments, in an embodiment of the present disclosure, the existing field of the DCI signaling for scheduling MSG3 include at least one of the following:
a TPC field of the DCI signaling for scheduling the MSG3;
a Harq Process Number HPN (High power Nide) field of the DCI signaling for scheduling the MSG3; or
an MCS field of the DCI signaling for scheduling the MSG3.

In some embodiments, in an embodiment of the present disclosure, the apparatus is also configured to:
acquire the second channel sent by the network device, the second channel is used to indicate the UE behavior or the target beam using a sixth preset manner;
the sixth preset manner includes: indicating the UE behavior or the target beam by using a time-frequency position arrangement of a DMRS in the second channel, where different time-frequency position arrangements indicate different UE behaviors or different target beams.

In some embodiments, in an embodiment of the present disclosure, the apparatus is also configured to:
acquire the second channel sent by the network device, the second channel is used to indicate the UE behavior or the target beam using a seventh preset manner;
the seventh preset manner includes: using a DMRS sequence in the second channel to indicate the beam used by the UE for transmission, where different DMRS sequences are used to indicate different UE behaviors or different target beams.

In some embodiments, in an embodiment of the present disclosure, the second channel includes at least one of the following:
a PDCCH for scheduling MSG3; or
a PDSCH for carrying MSG3.

In some embodiments, in an embodiment of the present disclosure, the apparatus is also configured to:
acquire the second signaling sent by the network device, the second signaling is used to indicate the target beam using an eighth preset manner;
the eighth preset manner includes: using a scrambling sequence corresponding to the second signaling to indicate the beam used by the UE for transmission, where the scrambling sequence is a scrambling sequence corresponding to an RO corresponding to any one of PRACHs historically sent by the UE, and the scrambling sequence is used to indicate a beam used by the RO corresponding to the scrambling sequence.

In some embodiments, in an embodiment of the present disclosure, the second signaling includes at least one of the following:
a DCI signaling for scheduling MSG3; or
a PDSCH for carrying MSG3.

FIG. 6 is a schematic diagram of the structure of a beam indication apparatus provided by an embodiment of the present disclosure. As shown in FIG. 6, the apparatus may include:
a sending module, configured to send a first signaling and/or a first channel to a UE, where the first signaling and/or the first channel is used to indicate a beam used by the UE for transmission;
a transmission module, configured to perform transmission using the beam.

In summary, in the beam indication apparatus provided by the embodiments of the present disclosure, the UE may acquire the first signaling and/or the first channel sent by the network device, the first signaling and/or the first channel may be used to indicate the beam, afterwards, the UE may determine the beam indicated by the first signaling and/or the first channel and perform the transmission using the beam indicated by the first signaling and/or the first channel. It may be seen that in the embodiments of the present disclosure, a beam indication method is provided, which may be used to indicate the best beam, such that subsequent UE may transmit with the network device based on the indicated beam, thereby improving the reliability of data transmission and enhancing data coverage.

In some embodiments, in an embodiment of the present disclosure, the sending module is further configured to:
send the first signaling to the UE, where the first signaling is used to indicate the beam used by the UE for transmission using a first preset manner;
the first preset manner includes: using an indication code included in the first signaling to indicate the beam used by the UE for transmission, where the indication code includes N bits, N is a positive integer, and different indication codes indicate different beams.

In some embodiments, in an embodiment of the present disclosure, a carrying position of the first signaling includes at least one of the following:
a reserved field of a DCI signaling for scheduling MSG2;
a reserved field of an MAC RAR of MSG2;
a newly-added byte(s) in an MAC RAR of MSG2;
an existing field in a UL Grant field of an MAC RAR of MSG2; or
a newly-added field in a UL Grant field of an MAC RAR of MSG2.

In some embodiments, in an embodiment of the present disclosure, the existing field in the UL Grant field includes at least one of the following:
a TPC field;
a CSI request field; or
an MCS field.

In some embodiments, in an embodiment of the present disclosure, the sending module is further configured to:
send the first channel to the UE, where the first channel is used to indicate the beam using a second preset manner:
the second preset manner includes: using a time-frequency position arrangement of a DMRS in the first channel to indicate the beam used by the UE for transmission, where different time-frequency position arrangements indicate different beams.

In some embodiments, in an embodiment of the present disclosure, the sending module is further configured to:
send the first channel to the UE, the first channel is used to indicate the beam used by the

UE for transmission using a third preset manner;
In some embodiments, in an embodiment of the present disclosure, the first channel includes at least one of the following:
a PDCCH for scheduling MSG2; or
a PDSCH for carrying MSG2.

In some embodiments, in an embodiment of the present disclosure, the sending module is further configured to:
send the first channel to the UE, the first channel is used to indicate the beam using a third preset manner, the third preset manner includes: using a DMRS sequence in the first channel to indicate the beam used by the UE for transmission, where different DMRS sequences are used to indicate different beams.

In some embodiments, in an embodiment of the present disclosure, the sending module is further configured to:
send the first signaling to the UE, where the first signaling is used to indicate the beam used by the UE for transmission using a fourth preset manner;
the fourth preset manner includes: using a scrambling sequence corresponding to the first signaling to indicate the beam used by the UE for transmission, where the scrambling sequence is a scrambling sequence corresponding to an RO corresponding to any one of PRACHs historically sent by the UE, and the scrambling sequence is used to indicate a beam used by the RO corresponding to the scrambling sequence.

In some embodiments, in an embodiment of the present disclosure, the first signaling includes at least one of the following:
a DCI signaling for scheduling MSG2; or
a PDSCH for carrying MSG2.

In some embodiments, in an embodiment of the present disclosure, the scrambling sequence is an RA-RNTI.

In some embodiments, in an embodiment of the present disclosure, the first signaling is used to indicate a best beam in a beam set, and the beam set includes beams used by the UE for historical transmissions;
the different preset manners are configured to jointly indicate a beam in the beam set, or different first signalings or different first channels of the same preset manner are configured to jointly indicate a beam in the beam set.

In some embodiments, in an embodiment of the present disclosure, the first signaling indicates the beam by indicating a bit value corresponding to the beam;
the sending module is further configured to:
send at least one first signaling to the UE, where carrying positions of different first signalings are different or the same, different first signalings indicate some or all of bit values corresponding to the beam, and bit values indicated by all first signalings are combined to form an entire bit value of the beam for indicating the beam.

In some embodiments, in an embodiment of the present disclosure, the apparatus is also configured to:
send a second signaling and/or a second signaling to the UE, the second signaling and/or the second signaling is used to indicate a UE behavior, the UE behavior includes any one of following: continuing to use the beam indicated by the first signaling and/or the first channel for transmission, randomly switching to a target beam for transmission, using a target beam for transmission when the second channel and/or the second signaling indicates the target beam, and autonomously re-determining, by the UE, a target beam for transmission.

In some embodiments, in an embodiment of the present disclosure, the apparatus is also configured to:
send the second signaling to the UE, the second signaling is used to indicate the UE behavior or the target beam using a fifth preset manner;
the fifth preset manner includes: using an indication code included in the second signaling to indicate the UE behavior or the target beam, where the indication code includes N bits, N is a positive integer, and different indication codes indicate different UE behaviors or different target beams.

In some embodiments, in an embodiment of the present disclosure, a carrying position of the second signaling includes at least one of the following:
a reserved field of a DCI signaling for scheduling MSG3;
an existing field of a DCI signaling for scheduling MSG3; or
a newly-added field of a DCI signaling for scheduling MSG3.

In some embodiments, in an embodiment of the present disclosure, the existing field of the DCI signaling for scheduling the MSG3 include at least one of the following:
a TPC field of the DCI signaling for scheduling the MSG3;
an HPN field of the DCI signaling for scheduling the MSG3; or
an MCS field of the DCI signaling for scheduling the MSG3.

In some embodiments, in an embodiment of the present disclosure, the apparatus is also configured to:
send the second channel to the UE, the second channel is used to indicate the UE behavior or the target beam used by the UE for transmission using a sixth preset manner;
the sixth preset manner includes: using a time-frequency position arrangement of a DMRS in the second channel to indicate the UE behavior or the target beam, where different time-frequency position arrangements indicate different UE behaviors or different target beams.

In some embodiments, in an embodiment of the present disclosure, the apparatus is also configured to:
send a second channel to the UE, the second channel is used to indicate the UE behavior or the target beam using a seventh preset manner;
the seventh preset manner includes: using a DMRS sequence in the second channel to indicate the beam, where different DMRS sequences are used to indicate different UE behaviors or different target beams.

In some embodiments, in an embodiment of the present disclosure, the second channel includes at least one of the following:
a PDCCH for scheduling MSG3; or
a PDSCH for carrying MSG3.

In some embodiments, in an embodiment of the present disclosure, the apparatus is also configured to:
send a second signaling to the UE, the second signaling is used to indicate the target beam using an eighth preset manner;
the eighth preset manner includes: using a scrambling sequence corresponding to the second signaling to indicate the beam used by the UE for transmission, where the scrambling sequence is a scrambling sequence corresponding to an RO corresponding to any one of PRACHs historically sent by the UE, and the scrambling sequence is used to indicate a beam used by the RO corresponding to the scrambling sequence.

In some embodiments, in an embodiment of the present disclosure, the second signaling includes at least one of the following:
a DCI signaling for scheduling MSG3; or
a PDSCH for carrying MSG3.

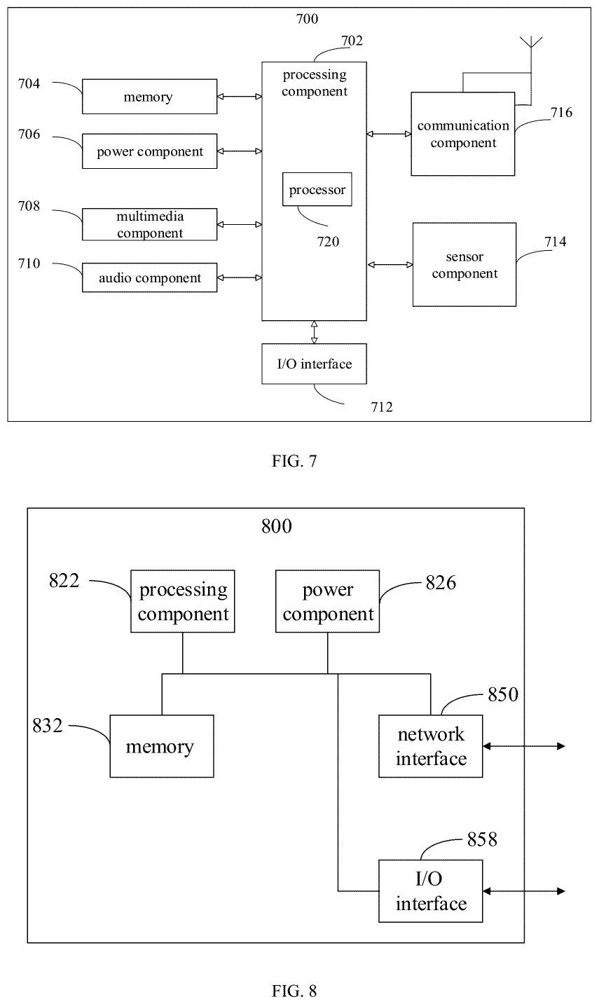

FIG. 7 is a block diagram of a user equipment UE 700 according to an embodiment of the present disclosure. The UE 700 may be a mobile phone, a computer, a digital broadcasting terminal, a message transceiver device, a game console, a tablet device, a medical device, a fitness device and a personal digital assistant, etc.

As illustrated in FIG. 7, the UE 700 may include one or more of the following components: a processing component 702, a memory 704, a power component 706, a multimedia component 708, an audio component 710, an input/output (I/O) interface 712, a sensor component 713, and a communication component 716.

The processing component 702 typically controls overall operations of the UE 700, such as the operations associated with display, telephone calls, data communications, camera operations, and recording operations. The processing component 702 may include one or more processors 720 to execute instructions to implement all or part of the steps in the above described method for reporting location-related information. Moreover, the processing component 702 may include one or more modules which facilitate the interaction between the processing component 702 and other components. For example, the processing component 702 may include a multimedia module to facilitate the interaction between the multimedia component 708 and the processing component 702.

The memory 704 is configured to store various types of data to support the operation of the UE 700. Examples of such data include instructions for any applications or methods operated on the UE 700, contact data, phonebook data, messages, pictures, videos, etc. The memory 704 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 706 provides power to various components of the UE 700. The power component 706 may include a power management system, one or more power sources, and any other components associated with the generation, management, and distribution of power in the UE 700.

The multimedia component 708 includes a screen providing an output interface between the UE 700 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensor may not only sense a boundary of a touch or swipe action, but also sense a period of time and a pressure associated with the touch or swipe action. In some embodiments, the multimedia component 708 includes a front-facing camera and/or a rear-facing camera. When the UE 700 is in an operating mode, such as a shooting mode or a video mode, the front-facing camera and/or the rear-facing camera can receive external multimedia data. Each front-facing camera and rear-facing camera may be a fixed optical lens system or has a focal length and optical zoom capability.

The audio component 710 is configured to output and/or input audio signals. For example, the audio component 710 includes a microphone (MIC) configured to receive an external audio signal when the UE 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 713 includes one or more sensors to provide status assessments of various aspects of the UE 700. For instance, the sensor component 713 may detect an open/closed status of the UE 700, relative positioning of components, e.g., the display and the keypad, of the UE 700, a change in position of the UE 700 or a component of the UE 700, a presence or absence of user contact with the UE 700, an orientation or an acceleration/deceleration of the UE 700, and a change in temperature of the UE 700. The sensor component 713 may include a proximity sensor configured to detect the presence of nearby objects without any physical contact. The sensor component 713 may also include a light sensor, such as a Complementary Metal Oxide Semiconductor (CMOS) or Charge-Coupled Device (CCD) image sensor, for use in imaging applications. In some embodiments, the sensor component 713 may also include an accelerometer sensor, a gyroscope sensor, a magnetic sensor, a pressure sensor, or a temperature sensor.

The communication component 716 is configured to facilitate communication, wired or wirelessly, between the UE 700 and other devices. The UE 700 can access a wireless network based on a communication standard, such as Wi-Fi, 2G or 3G, or a combination thereof. In an embodiment, the communication component 716 receives a broadcast signal from an external broadcast management system or broadcast associated information via a broadcast channel. In an embodiment, the communication component 716 further includes a Near Field Communication (NFC) module to facilitate short-range communication. For example, the NFC module may be implemented based on a RF Identification (RFID) technology, an Infrared Data Association (IrDA) technology, an Ultra-Wide Band (UWB) technology, a Blue Tooth (BT) technology, and other technologies.

In the embodiment, the UE 700 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above method.

FIG. 8 is a block diagram of a network side device 800 according to an embodiment of the present disclosure. The network side device 800 may be provided as a network side device. As illustrated in FIG. 8, the network side device 800 includes a processing component 811 consisting of one or more processors, and memory resources represented by a memory 832 for storing instructions that may be executed by the processing component 822, such as applications. The applications stored in the memory 832 may include one or more modules each corresponding to a set of instructions. In addition, the processing component 822 is configured to execute the instructions to implement the method applied to the network side device as described above, for example, the method illustrated in FIG. 1.

The network side device 800 may also include a power component 826 configured to perform power management of the network side device 800, a wired or wireless network interface 850 configured to connect the network side device 800 to a network, and an input/output (I/O) interface 858. The network side device 800 may operate based on an operating system stored in the memory 832, such as Windows Server™, Mac OS X™, Unix™, Linux™, FreeBSD™, or the like.

In the above embodiments of the present disclosure, the methods according to the embodiments of the present disclosure are described from the perspectives of the network side device and the UE, respectively. In order to realize each of the functions in the methods according to the above embodiments of the present disclosure, the network side device and the UE may include a hardware structure, a software module, and realize each of the above functions in the form of hardware structure, software module, or a combination of hardware structure and software module. A certain function of the above functions may be performed in the form of hardware structure, software module, or a combination of hardware structure and software module.

In the above embodiments of the present disclosure, the methods according to the embodiments of the present disclosure are described from the perspectives of the network side device and the UE, respectively. In order to realize each of the functions in the methods according to the above embodiments of the present disclosure, the network side device and the UE may include a hardware structure, a software module, and realize each of the above functions in the form of hardware structure, software module, or a combination of hardware structure and software module. A certain function of the above functions may be performed in the form of hardware structure, software module, or a combination of hardware structure and software module.

An embodiment of the present disclosure further provides a communication apparatus. The communication apparatus may include a transceiver module and a processing module. The transceiver module may include a sending module and/or a receiving module. The sending module is configured to implement a sending function. The receiving module is configured to implement a receiving function. The transceiver module may implement the sending function and/or the receiving function.

The communication apparatus may be a terminal device (such as the terminal device in the foregoing method embodiments), or may be an apparatus in the terminal device, or may be an apparatus capable of being used in combination with the terminal device. Alternatively, the communication apparatus may be a network device, or may be an apparatus in the network device, or may be an apparatus capable of being used in combination with the network device.

An embodiment of the present disclosure further provides another communication apparatus. The communication apparatus may be a network device or a terminal device (such as the terminal device in the foregoing method embodiments), or may be a chip, a chip system or a processor that supports the network device to realize the above-described methods, or may be a chip, a chip system or a processor that supports the terminal device to realize the above-described methods. The apparatus may be used to realize the methods described in the above method embodiments with reference to the description of the above-described method embodiments.

The communication device may include one or more processors. The processor may be a general purpose processor or a dedicated processor, such as, a baseband processor and a central processor. The baseband processor is used for processing communication protocols and communication data. The central processor is used for controlling the communication apparatus (e.g., a base station, a baseband chip, a terminal device, a terminal device chip, a DU, or a CU), executing computer programs, and processing data of the computer programs.

In some embodiments, the communication apparatus may include one or more memories on which computer programs may be stored. The processor executes the computer programs to cause the communication apparatus to perform the methods described in the above method embodiments. Alternatively, the memory may also store data. The communication apparatus and the memory may be provided separately or may be integrated together.

In some embodiments, the communication apparatus may also include a transceiver and an antenna. The transceiver may be referred to as a transceiver unit, a transceiver machine, or a transceiver circuit, for realizing a transceiver function. The transceiver may include a receiver and a transmitter. The receiver may be referred to as a receiving machine or a receiving circuit, for realizing the receiving function. The transmitter may be referred to as a transmitter machine or a transmitting circuit, for realizing the transmitting function.

In some embodiments, the communication apparatus may also include one or more interface circuits. The interface circuits are used to receive code instructions and transmit them to the processor. The processor runs the code instructions to cause the communication apparatus 70 to perform the method described in the method embodiments.

The communication apparatus is the terminal device (such as the terminal device in the foregoing method embodiments): the processor is configured to perform the method illustrated in any of FIG. 1 to FIG. 4.

The communication apparatus is the network device, and the transceiver is configured to perform the method illustrated in any of FIG. 5 to FIG. 7.

In an implementation, the processor may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor may store a computer program. When the computer program runs on the processor, the communication apparatus is caused to perform the methods described in the method embodiments above. The computer program may be solidified in the processor, and in such case the processor may be implemented by hardware.

In an implementation, the communication apparatus may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the description of the above embodiments may be a network device or a terminal device (such as the terminal device in the foregoing method embodiments), but the scope of the communication apparatus described in the present disclosure is not limited thereto, and the structure of the communication apparatus may not be limited. The communication apparatus may be a stand-alone device or may be part of a larger device. For example, the described communication apparatus may be:
(1) a stand-alone IC, a chip, a chip system or a subsystem;
(2) a collection of ICs including one or more ICs, in some embodiments, the collection of ICs may also include storage components for storing data and computer programs;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

The case where the communication apparatus may be a chip or a chip system is described with reference to the schematic structure of the chip. The chip includes a processor and an interface. There may be one or more processors, and there may be multiple interfaces.

Alternatively, the chip further includes a memory, and the memory is configured to store necessary computer programs and data.

It is understood by those skilled in the art that various illustrative logical blocks and steps listed in the embodiments of the present disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the present disclosure.

The embodiments of the present disclosure further provide a system, in which the system includes a communication apparatus acting as a terminal device (such as the first terminal device in the foregoing method embodiments) and a communication apparatus acting as a network device in the foregoing embodiment, or the system include a communication apparatus acting as a terminal device (such as the first terminal device in the foregoing method embodiments) and a communication apparatus acting as a network device in the foregoing embodiment.

The present disclosure further provides a non-transitory readable storage medium having stored thereon instructions that, when executed by a computer, the functions of any of the foregoing method embodiments are implemented.

The present disclosure further provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the present disclosure is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art can understand that the first, second, and other various numerical numbers involved in the present disclosure are only described for the convenience of differentiation, and are not used to limit the scope of the embodiments of the present disclosure, or used to indicate the order of precedence.

The term “at least one” in the present disclosure may also be described as one or more, and the term “multiple” may be two, three, four, or more, which is not limited in the present disclosure. In the embodiments of the present disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

Other embodiments of the present disclosure will be apparent to those skilled in the art from consideration of the specification and practice of the present disclosure disclosed here. The present disclosure is intended to cover any variations, usages, or adaptations of the embodiments of the present disclosure following the general principles thereof and including such departures from the present disclosure as come within known or customary practice in the art. It is intended that the specification and embodiments are considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A beam indication method, performed by a user equipment (UE), comprising:
receiving at least one of a first signaling or a first channel sent by a network device, wherein at least one of the first signaling or the first channel is used to indicate a beam;
determining the beam indicated by at least one of the first signaling or the first channel; and
performing transmission using the beam.

2. The method according to claim 1, wherein receiving at least one of the first signaling or the first channel sent by the network device comprises:
receiving the first signaling sent by the network device, wherein the first signaling is used to indicate the beam using a first preset manner;
the first preset manner comprises: indicating the beam by using a first indication code comprised in the first signaling, wherein the first indication code comprises N bits, N is a positive integer, and different first indication codes indicate different beams.

3. The method according to claim 2, wherein a carrying position of the first signaling comprises at least one of following:
a reserved field of a Downlink Control Information (DCI) signaling for scheduling an MSG2;
a reserved field of a Media Access Control layer-Random Access Response (MAC RAR) of an MSG2;
a newly-added byte(s) in an MAC RAR of an MSG2;
an existing field in an Uplink Grant (UL Grant) field of an MAC RAR of an MSG2; or
a newly-added field in a UL Grant field of an MAC RAR of an MSG2.

4. The method according to claim 3, wherein the existing field in the UL Grant field comprises at least one of following:
a Transmit Power Control (TPC) field;
a Channel State Information request (CSI) request field; or
a Modulation and Coding Scheme (MCS) field.

5. The method according to claim 1, wherein receiving at least one of the first signaling or the first channel sent by the network device comprises:
receiving the first channel sent by the network device, wherein the first channel is used to indicate the beam using a second preset manner;
the second preset manner comprises: indicating the beam by using a time-frequency resource location of a Demodulation Reference Signal (DMRS) in the first channel, wherein different time-frequency resource locations indicate different beams.

6. The method according to claim 1, wherein receiving at least one of the first signaling or the first channel sent by the network device comprises:
receiving the first channel sent by the network device, wherein the first channel is used to indicate the beam using a third preset manner;
the third preset manner comprises: indicating the beam by using a DMRS sequence in the first channel, wherein different DMRS sequences are used to indicate different beams.

7. The method according to claim 5, wherein the first channel comprises at least one of following:
a Physical Downlink Control Channel (PDCCH) for scheduling an MSG2; or
a Physical Downlink Shared Channel (PDSCH) for carrying an MSG2.

8. The method according to claim 1, wherein receiving at least one of the first signaling or the first channel sent by the network device comprises:
receiving the first signaling sent by the network device, wherein the first signaling is used to indicate the beam using a fourth preset manner;
the fourth preset manner comprises: indicating the beam by using a scrambling sequence corresponding to the first signaling, wherein the scrambling sequence is a scrambling sequence corresponding to a Random Access Channel Occcasion (RO) corresponding to any one of Physical Random Access Channels (PRACHs) sent by the UE, and the scrambling sequence is used to indicate a beam used by the RO corresponding to the scrambling sequence.

9. The method according to claim 8, wherein the first signaling comprises at least one of following:
a DCI signaling for scheduling an MSG2; or
a Physical Downlink Shared Channel (PDSCH) for carrying an MSG2.

10.-13. (canceled)

14. The method according to claim 8, wherein determining the beam indicated by the first signaling comprises:
performing blind-decoding on the first signaling based on each scrambling sequence corresponding to each RO of each PRACH of the PRACHs sent by the UE;
determining a scrambling sequence successfully decoding the first signaling; and
determining a beam used by an RO corresponding to the scrambling sequence which is used to successfully decode the first signaling as the beam indicated by the first signaling.

15. (canceled)

16. The method according to claim 2, wherein the first signaling indicates the beam by indicating a bit value corresponding to the beam;
receiving the first signaling sent by the network device comprises:
receiving at least one first signaling sent by the network device, wherein carrying positions of different first signalings are different or same, different first signalings indicate some or all of bit values corresponding to the beam, and the bit values indicated by all first signalings are combined to form an entire bit value for indicating the beam.

17. The method according to claim 1, further comprising one of following:
receiving at least one of a second channel or a second signaling sent by the network device, wherein the at least one of the second channel or the second signaling is used to indicate a UE behavior,
and
performing a corresponding operation based on the UE behavior indicated by the at least one of the second channel or the second signaling; or
randomly switching to a target beam for transmission, or
autonomously re-determining, by the UE, a target beam for transmission.

18. The method according to claim 17, wherein receiving the at least one of the second channel or the second signaling sent by the network device comprises:
receiving the second signaling sent by the network device, wherein the second signaling is used to indicate the UE behavior or the target beam using a fifth preset manner;
the fifth preset manner comprises: indicating the UE behavior or the target beam by using a second indication code comprised in the second signaling, wherein the second indication code comprises N bits, N is a positive integer, and different second indication code values indicate different UE behaviors or different target beams.

19. The method according to claim 18, wherein a carrying position of the second signaling comprises at least one of following:
a reserved field of a DCI signaling for scheduling an MSG3;
an existing field of a DCI signaling for scheduling an MSG3; or
a newly-added field of a DCI signaling for scheduling an MSG3.

20. (canceled)

21. The method according to claim 17, wherein receiving the at least one of the second channel or the second signaling sent by the network device comprises:
receiving the second channel sent by the network device, wherein the second channel is used to indicate the UE behavior or the target beam using a sixth preset manner;
the sixth preset manner comprises: indicating the UE behavior or the target beam by using a time-frequency resource location of a DMRS in the second channel, wherein different time-frequency resource locations indicate different UE behaviors or different target beams.

22. The method according to claim 17, wherein receiving the at least one of the second channel or the second signaling sent by the network device comprises:
receiving the second channel sent by the network device, wherein the second channel is used to indicate the UE behavior or the target beam using a seventh preset manner;
the seventh preset manner comprises: indicating the beam by using a DMRS sequence in the second channel, wherein different DMRS sequences are used to indicate different UE behaviors or different target beams.

23. The method according to claim 17, wherein the second channel comprises at least one of following:
a PDCCH for scheduling an MSG3; or
a PDSCH for carrying an MSG3.

24. The method according to claim 17, wherein receiving the at least one of the second channel or the second signaling sent by the network device comprises:
receiving the second signaling sent by the network device, wherein the second signaling is used to indicate the target beam using an eighth preset manner;
the eighth preset manner comprises: indicating the beam by using a scrambling sequence corresponding to the second signaling, wherein the scrambling sequence is a scrambling sequence corresponding to an RO corresponding to any one of PRACHs sent by the UE, and the scrambling sequence is used to indicate a beam used by the RO corresponding to the scrambling sequence;
wherein the second signaling comprises at least one of following:
a DCI signaling for scheduling an MSG3; or
a PDSCH for carrying an MSG3.

25. (canceled)

26. A beam indication method, performed a network device, comprising:
sending at least one of a first signaling or a first channel to a UE, wherein at least one of the first signaling or the first channel is used to indicate a beam; and
performing transmission using the beam.

27.-48. (canceled)

49. A communication apparatus, wherein the apparatus comprises a processor and a memory, wherein the memory stores a computer program, and the processor executes the computer program stored in the memory to cause the apparatus to:
receive at least one of a first signaling or a first channel sent by a network device, wherein at least one of the first signaling or the first channel is used to indicate a beam;
determine the beam indicated by at least one of the first signaling or the first channel; and
perform transmission using the beam.

50.-54. (canceled)
